(19) United States
(12) Patent Application Publication
(10) Pub. No.: US 2026/0332671 A1
(43) Pub. Date: Oct. 22, 2026

(54) Anomaly Detection in Wastewater Networks

(71) Applicant: Stormharvester IPR Limited, Belfast (IE)

(72) Inventors: Brian Joseph Moloney, Belfast (IE); Stephen Richard Gallagher, Belfast (IE)

(21) Appl. No.: 19/113,320

(22) PCT Filed: Sep. 20, 2023
(86) PCT No.: PCT/EP2023/075965

§ 371 Date: Mar. 19, 2025

(30) Foreign Application Priority Data
Sep. 20, 2022 (GB) GB202213748A

(51) Int. Cl. H04L 67/125; C02F 1/00; G06N 20/00

(52) U.S. Cl. CPC H04L 67/125; C02F 1/00; G06N 20/00; C02F 2209/001

(57) ABSTRACT

Methods, apparatus and systems are provided for detecting anomalies at a wastewater asset of a wastewater network. The wastewater asset comprising a sensor configured for performing measurements associated with wastewater flow through the wastewater asset. Current rainfall data associated with the wastewater asset is received. Receiving, from the sensor of the wastewater asset, real-time wastewater measurements associated with the wastewater flow at the wastewater asset. Applying the received current rainfall data to a trained machine learning model configured for predicting, in real-time, minimum and maximum thresholds associated with wastewater flow through the wastewater asset. Detecting an anomaly at the wastewater asset when one or more real-time wastewater measurements at the wastewater asset exceeds the corresponding predicted maximum wastewater threshold and/or reaches below the corresponding predicted minimum wastewater threshold over a time interval. Sending an indication of the detected anomaly at the wastewater asset

### TECHNICAL FIELD

The present application relates to apparatus, systems and method(s) for detecting anomalies in wastewater networks.

### BACKGROUND

Wastewater networks include a plurality of wastewater assets (e.g. manholes, wastewater pumping stations and the like) interconnected by a plurality of wastewater pipes (e.g. sewer pipes, storm water drains, and the like) that receives wastewater which flows through the pipes under gravity to a waste water treatment works and the like. Waste water includes storm water, sewerage, and/or any other wastewater run-off from roads, land, farms, homes and/or business premises that enter the wastewater network via gutters and/or private sewer/storm water drains. One or more of the wastewater assets may have an overflow mechanism/pipe to prevent wastewater from flooding out of one or more wastewater assets in the event of excessive wastewater flow caused by environmental events such as, without limitation, for example storms and/or excessive rainfall or manmade events such as, without limitation, for example burst drinking water mains/pipes and the like, where the wastewater may flood and contaminate land, homes, businesses, and the like. The overflow may be directed via the overflow pipe/mechanism towards nearby river and/or the sea.

The overflow mechanisms/pipes are only meant to be used in emergencies or extreme events where the wastewater network may be overwhelmed.

However, blockages and/or debris within the wastewater pipes and/or wastewater assets may also cause the overflow mechanism to be used unnecessarily to prevent any flooding of wastewater exiting above street level or out onto the land, which requires costly clean-up and treatment. Conventional wastewater networks may rely on an operator of the wastewater network to schedule routine cleaning of all wastewater assets and pipes throughout the year to minimise the occurrence of such blockages and events. This can be costly and slow. Often, the public or local communities may notify when a wastewater asset has been overwhelmed and flooded (e.g. after a storm event), which is often too late to prevent contamination, costly clean-up and maintenance of the area around the wastewater asset.

There is a desire for an improved wastewater management system that accurately, efficiently, and predictability detects anomalies and/or blockages within wastewater networks and/or wastewater assets for the efficient management and maintenance of said networks and assets to prevent unnecessary overflow.

### SUMMARY

This Summary is provided to introduce a selection of concepts in a simplified form that are further described below in the Detailed Description. This Summary is not intended to identify key features or essential features of the claimed subject matter, nor is it intended to be used to determine the scope of the claimed subject matter; variants and alternative features which facilitate the working of the invention and/or serve to achieve a substantially similar technical effect should be considered as falling into the scope of the invention disclosed herein.

The present disclosure provides method(s), apparatus and system(s) for detecting anomalies at a wastewater asset of a wastewater network, the wastewater asset comprising a sensor configured for performing measurements associated with wastewater flow through the wastewater asset. The method(s), apparatus and system(s) configured for comparing received real-time wastewater measurements associated with the wastewater flow at the wastewater asset and received predictions of wastewater flow through the wastewater asset from an trained machine learning model configured output predictions of wastewater flow through the wastewater asset based on inputs including current environmental data such as, without limitation, for example current rainfall data associated with the wastewater asset and/or other current environmental data that may affect the flow of wastewater through the wastewater; and detecting an anomaly at the wastewater asset based on a comparison between the real-time wastewater measurements and the predicted wastewater flow through the wastewater asset exhibit patterns associated with anomalous behaviour in relation to wastewater asset, and, when detected, sending an indication of the detected anomaly at the wastewater asset to an operator monitoring the wastewater network.

In a first aspect of this specification, there is disclosed a computer-implemented method of detecting anomalies at a wastewater asset of a wastewater network, the wastewater asset comprising a sensor configured for performing measurements associated with wastewater flow through the wastewater asset, the method comprising: receiving current environmental data comprising rainfall data associated with the wastewater asset, the current environmental data affecting the flow of wastewater through the wastewater asset; receiving, from the sensor of the wastewater asset, real-time wastewater measurements associated with the wastewater flow at the wastewater asset; applying the received current environmental data to a trained machine learning model configured for predicting, in real-time, minimum and maximum thresholds associated with wastewater flow through the wastewater asset; detecting an anomaly at the wastewater asset when one or more of multiple real-time wastewater measurements at the wastewater asset at least exceeds the corresponding predicted maximum wastewater threshold and/or reaches below the corresponding predicted minimum wastewater threshold over an anomaly duration associated with the anomaly; and sending an indication of the detected anomaly at the wastewater asset to an operator monitoring the wastewater network.

As an option, the computer-implemented method further including, wherein the sensor comprising at least one sensor from the group of: water level sensor; water flow sensor; water pressure sensor; current pumping sensor; any other sensor configured for performing measurements associated with the wastewater flow through the wastewater asset.

As another option, the computer-implemented method further including, wherein detecting the anomaly further comprises comparing the pattern created by the one or more multiple real-time wastewater measurements in relation to the predicted maximum and/or minimum thresholds over the time interval against a set of anomaly patterns, each anomaly pattern defining a specific type of anomaly.

As a further option, the computer-implemented method further including, wherein detecting the anomaly further comprises identifying an anomaly based on a similar or matching anomaly pattern, and determining the identified anomaly has been detected when the pattern created by the real-time wastewater measurements meets an anomaly duration associated with the anomaly pattern.

Optionally, the computer-implemented method further including, wherein the anomaly may be based on one or more from the group of: an upstream blockage; a downstream blockage; a measurement sensor fault or error; and any other type of anomaly detectable via wastewater flowing through said wastewater asset.

As an option, the computer-implemented method further including, wherein the measurement sensor fault or error comprises at least one from the group of: sensor misalignment issue; sensor calibration issue; sensor communications issue; sensor obstacle issue; and any other sensor fault, error or issue causing incorrect wastewater measurements being performed at the wastewater asset.

As another option, the computer-implemented method further including, wherein detecting the anomaly further comprising: detecting a downstream blockage of the wastewater network downstream of the wastewater asset when the wastewater measurements exceeds the predicted maximum wastewater threshold for multiple contiguous time instances over an anomaly duration associated with downstream blockage; detecting a upstream blockage of the wastewater network that is upstream of the wastewater asset when the wastewater measurements are less than the predicted minimum wastewater threshold for multiple contiguous time instances over an anomaly duration associated with upstream blockage; detecting a measurement sensor anomaly when the wastewater measurements oscillates between inside and outside the limits set by the predicted maximum wastewater threshold and/or the predicted minimum wastewater threshold over multiple contiguous time instances over an anomaly duration associated with a sensor anomaly.

As an option, the computer-implemented method further including, further comprising normalising the received wastewater measurements based on a maximum and minimum capacity of the wastewater asset, and using the normalised wastewater measurements for detecting the anomaly.

As another option, the computer-implemented method further including, wherein detecting the anomaly further comprising detecting the anomaly at the wastewater asset when one or more of multiple real-time normalised wastewater measurements at the wastewater asset at least exceeds the corresponding predicted maximum wastewater threshold and/or reaches below the corresponding predicted minimum wastewater threshold over an anomaly duration associated with the anomaly.

As a further option, the computer-implemented method further including, wherein the environmental data associated with the wastewater asset comprises one or more types of environmental data from the group of: rainfall data; river level data; tidal data; flood water level data; ground water level data; any other type of environmental data affecting the wastewater flow through the wastewater asset.

As another option, the computer-implemented method further including, wherein applying the received current environmental data to the trained ML model further comprising: synchronising the time series received current environmental data with a common time interval M between datapoints, the common time interval M used by the training dataset for training said trained ML model;

depending on the type of environmental data, estimating hyper-local environmental data based on processing one or more types of the synchronised received current environmental data; inputting the processed synchronised current environmental data to the trained ML model configured for outputting a prediction of the minimum and maximum wastewater thresholds associated with wastewater flow through the wastewater asset.

As a further option, the computer-implemented method further including, wherein the received current environmental data comprises rainfall data associated with the wastewater asset, the rainfall data including first rainfall data corresponding to a first rainfall area the wastewater asset is located within, and a plurality of other rainfall data corresponding to rainfall areas adjacent to the first rainfall area, wherein applying the received current environmental data to the trained ML model further comprising: calculating a hyper-local rainfall estimate at the location of the wastewater asset based a weighted combination of the first rainfall estimate and the plurality of other rainfall data in relation to the location of the wastewater asset within the first rainfall area and the relative location of the wastewater asset to each of the plurality of other rainfall areas; and inputting the current hyper-local rainfall estimate to the trained ML model configured for outputting a prediction of the minimum and maximum wastewater thresholds associated with wastewater flow through the wastewater asset.

As another option, the computer-implemented method further including calculating the hyper-local rainfall estimate associated with the wastewater asset further comprising performing at least one of: a multivariate interpolation in relation to at least the first rainfall data and the plurality of other rainfall data and location of the wastewater asset in relation to the first and other rainfall areas; a three-dimensional interpolation in relation to at least the first rainfall data and the plurality of other rainfall data and location of the wastewater asset in relation to the first and other rainfall areas; a tri-linear interpolation in relation to at least the first rainfall data and the plurality of other rainfall data and location of the wastewater asset in relation to the first and other rainfall areas; a tri-cubic interpolation in relation to at least the first rainfall data and the plurality of other rainfall data and location of the wastewater asset in relation to the first and other rainfall areas; or any other numerical, estimation or interpolation method for estimating the hyper-local rainfall at the location of the wastewater asset based on at least the first rainfall data and the plurality of other rainfall data and location of the wastewater asset in relation to the first and other rainfall areas.

Optionally, the computer-implemented method further including wherein calculating the hyper-local rainfall estimate associated with the wastewater asset based on an interpolation method further comprising: dividing a rainfall grid area in which the wastewater asset is located within into quadrants; identifying the grid area quadrant of the rainfall grid area that the wastewater asset is located within; selecting at least three rainfall grid areas adjacent to the identified grid area quadrant the wastewater asset is located within; calculating a rectangle formed from the centers of the at least three rainfall grid areas and the rainfall grid area the wastewater asset is located within, wherein the wastewater asset is located within said rectangle; projecting the location of the wastewater asset onto each of the line segments or edges of the rectangle based on orthogonally projecting lines from the wastewater asset to each line segment or edge to form intersection locations on each line segment or edge for estimating intersection rainfall dataset estimates for said line segments or edges;

calculating, for each line segment or edge of the rectangle, an intersection rainfall estimate dataset based a linear interpolation using distances between each center of the grid areas corresponding to said each line segment or edge and the intersection location for said each line segment and the corresponding rainfall datasets associated with said centers the grid areas; calculating, for each projection line, an intermediate rainfall estimate dataset based a linear interpolation using distances between each pair of intersection locations on said each projection line and said wastewater asset and the corresponding intersection estimate rainfall datasets associated with said intersection locations on said each projection line; and calculating a hyperlocal rainfall dataset for said wastewater asset based on averaging the intermediate rainfall estimate datasets.

As an option, the computer-implemented method further including performing training of the ML model based on using an ML algorithm to train model parameters defining the ML model for predicting minimum and maximum thresholds associated with wastewater flow through the wastewater asset for use in anomaly detection based on a training dataset comprising data representative of historical wastewater measurement data for the wastewater asset and historical environmental data comprising historical rainfall data associated with the wastewater asset.

As another option, the computer-implemented method further including normalising the historical wastewater measurement data based on the maximum and minimum capacity of the wastewater asset.

As an option, the computer-implemented method further including processing the timeseries normalised historical wastewater measurement data for the wastewater asset to be synchronised with the timeseries rainfall data of the historical environmental data associated with the wastewater asset.

As a further option, the computer-implemented method further including wherein training further comprising: performing hyperparameter tuning using the ML algorithm based on training a plurality of sets of ML models using different combinations of hyperparameters, each set of ML models comprising a mean ML model, a minimum ML model and a maximum ML model, wherein: the mean ML model is trained and configured for predicting the time series mean values in the normalised historical wastewater measurement data based on at least rainfall data as input; the minimum ML model is trained and configured for predicting the time series minimum values in the normalised historical wastewater measurement data based on at least rainfall data as input; and the maximum ML model is trained and configured for predicting the time series maximum values in the normalised historical wastewater measurement data based on at least rainfall data as input; scoring and ranking each of the trained ML models of the plurality of sets of ML models based on root mean squared error and mean squared error; selecting the best ranked trained ML model; selecting the corresponding minimum and maximum trained ML models from the set of ML models that the selected best ranked trained ML model belongs; generating the final trained ML model for predicting minimum and maximum wastewater thresholds based on using the selected minimum and maximum trained ML models.

As another option, the computer-implemented method further including wherein training further comprising: performing hyperparameter tuning of the ML algorithm based on training a plurality of ML models using different combinations of hyperparameters associated with the ML algorithm and training dataset, wherein each comprises a mean ML model trained and configured for predicting the time series mean values in the normalised historical wastewater measurement data based on at least rainfall data as input; scoring and ranking each of the trained mean ML models of the plurality of ML models based on root mean squared error and mean squared error model performance metrics; selecting the best ranked trained mean ML model; using the hyperparameters of the selected best ranked trained mean ML model to generate a corresponding minimum and maximum trained ML models, wherein: the minimum ML model is trained and configured for predicting the time series minimum values in the normalised historical wastewater measurement data based on at least rainfall data as input; and the maximum ML model is trained and configured for predicting the time series maximum values in the normalised historical wastewater measurement data based on at least rainfall data as input; generating the final trained ML model for predicting minimum and maximum wastewater thresholds based on using the corresponding minimum and maximum trained ML models.

As an option, the computer-implemented method further including, wherein the hyperparameters associated with the training dataset include a set of rainfall data time windows, wherein each rainfall data time window corresponds to, for each current rainfall data instance, inputting during training or inference the current rainfall data instance and a plurality of preceding rainfall data instances within said each rainfall data time window.

As another option, the computer-implemented method further including, wherein the historical rainfall data is a timeseries dataset with a time interval M between datapoints, and the historical wastewater measurement data is a timeseries dataset with a time interval N between datapoints, where M>=N, further comprising generating a synchronised historical wastewater measurement dataset that forms a timeseries dataset with a time interval M between datapoints based on calculating the mean, minimum and maximum for each i-th datapoint from those datapoints of the historical wastewater measurement data falling between the (i-1)-th datapoint and the i-th datapoint within said each time interval M, wherein the training dataset comprises the mean, minimum and maximum values of the synchronised historical wastewater measurement dataset.

As an option, the computer-implemented method further including, further comprising: performing a first data clean-up of the normalised synchronised historical wastewater measurement dataset based on: performing statistical analysis of the normalised synchronised historical wastewater measurement dataset for identifying blocks of outlier datapoints; generating a first clean wastewater measurement dataset based on removing the identified outlier datapoints from the normalised synchronised historical wastewater measurement dataset; and generating a first rainfall dataset based on removing the corresponding rainfall datapoints associated with the identified outlier datapoints from the historical rainfall data; performing second data clean-up of the first clean wastewater measurement dataset based on: performing further statistical analysis to analyse long and short-term average behaviour of the first clean wastewater measurement dataset for identifying, based on a ruleset, inaccurate of discontinuous measurement data for interpolation or removal; generating a second clean wastewater measurement dataset based on filtering the identified measurement data using interpolation or removal; and generating a second rainfall dataset based on removing the corresponding rainfall datapoints associated with the removed datapoints from the first clean wastewater measurement dataset from the historical rainfall dataset; performing a third data clean-up of the second clean wastewater measurement dataset based on: identifying from the second clean wastewater measurement dataset exclusion events comprising one or more of: a) blockage and sensor fault events; b) rainfall events; c) dry weather events; and/or d) other feature events causing noisy or spurious data; generating a clean wastewater measurement dataset based on removing the blockage and sensor fault events and other feature events causing noise or spurious data from the second clean wastewater measurement dataset; and generating a clean rainfall dataset based on removing the corresponding rainfall datapoints associated with the removed identified outlier datapoints from the historical rainfall data; and generating the training dataset based on the clean wastewater measurement dataset and the clean third rainfall dataset.

As another option, the computer-implemented method further including generating a dry weather dataset for the wastewater asset based on removing identified rainfall events from the clean wastewater measurement dataset. As an option, the computer-implemented method further including, further comprising: training a dry weather ML model based on using an ML algorithm to train model parameters defining the dry weather ML model for predicting minimum and maximum dry weather thresholds associated with wastewater flow through the wastewater asset for use in anomaly detection based on a training dry weather dataset comprising data representative of the generated dry weather dataset; and training a wet weather ML model based on using the ML algorithm to train model parameters defining the wet weather ML model for predicting minimum and maximum wet weather thresholds associated with wastewater flow through the wastewater asset for use in anomaly detection based on a training dataset comprising data representative of the clean wastewater measurement dataset and the clean third rainfall dataset associated with the wastewater asset; forming a trained ML model based on the trained dry weather ML model and trained wet weather ML model, wherein the trained ML model is configured to predict minimum and maximum wastewater thresholds, where the predicted minimum wastewater threshold comprises a combination of the predicted minimum dry weather threshold and the predicted minimum wet weather threshold, and the predicted maximum wastewater threshold comprises a combination of the predicted maximum dry weather threshold and the predicted maximum wet weather threshold.

As another option, the computer-implemented method further including, performing statistical analysis of the normalised synchronised historical wastewater measurement dataset for identifying blocks of outlier datapoints further comprising: generating a histogram dispersion graph for the normalised synchronised historical wastewater measurement dataset; identifying the outlier blocks, if any, in the histogram dispersion graph based on comparing the histogram dispersion graph with an ideal histogram data pattern associated with the wastewater asset; generating the first clean wastewater dataset based on removing any identified outlier blocks from the normalised synchronised historical wastewater measurement dataset.

As an option, the computer-implemented method further including, wherein the normalised synchronised historical wastewater measurement dataset includes a plurality of current normalised synchronised wastewater measurements, the method further comprising: generating a histogram dispersion graph for the normalised synchronised historical wastewater measurement dataset; identifying the outlier blocks, if any, in the histogram dispersion graph based on comparing the histogram dispersion graph with an ideal histogram data pattern associated with the wastewater asset; determining whether any of the identified outlier blocks include one or more of the plurality of current normalised synchronised wastewater measurements for an anomaly duration period or time window up to a current time instance; and detecting an anomaly based on the determination. As another option, the computer-implemented method further including identifying the detected anomaly based on: identifying the type of sensor anomaly based on matching or comparing the identified outlier blocks with one or more anomaly statistical patterns, the anomaly statistical patterns including at least one of an iron step pattern, sensor misalignment pattern and a sensor calibration pattern. As a further option, the computer-implemented method further including identifying a type of sensor anomaly based on matching or comparing the identified outlier blocks with one or more anomaly statistical patterns, the anomaly statistical patterns including at least one of an iron step pattern, sensor misalignment pattern and a sensor calibration pattern; or identifying any other type of anomaly based on matching or comparing the identified outlier blocks with one or more corresponding anomaly statistical patterns associated thereto.

As an further option, the computer-implemented method further including wherein the ML algorithm comprising at least one from the group of: regression learning algorithm; neural network; extreme gradient boost regressor algorithm; Adaptive Boosting algorithm; Gradient boosting algorithm; any other statistical classification meta-algorithm; any other ML algorithm suitable for training model parameters of an ML model for tracking the behaviour of wastewater flow through a wastewater asset and for predicting data representative of a minimum wastewater threshold and maximum wastewater threshold for said wastewater asset.

As another option, the computer-implemented method further including, wherein the ML algorithm comprises a regression learning algorithm based on one or more of: extreme gradient boost regressor algorithm; Adaptive Boosting algorithm; Gradient boosting algorithm; any other statistical classification meta-algorithm, boosting algorithm or regression algorithm suitable for training model parameters of an ML model for tracking the behaviour of wastewater flow through a wastewater asset and for predicting data representative of a minimum wastewater threshold and maximum wastewater threshold for said wastewater asset.

As a further option, the computer-implemented method of the first aspect, wherein the computer-implemented method is a method of operating an anomaly detection apparatus for detecting anomalies at one or more wastewater assets of the wastewater network, the wastewater network further comprising a plurality of wastewater assets, each wastewater asset connected to another wastewater asset of the plurality of wastewater assets by a corresponding wastewater pipe to form the wastewater network, each wastewater asset comprising a sensor configured for performing measurements associated with wastewater flow through the wastewater asset, the method further comprising: performing anomaly detection for each of the wastewater assets of the plurality of wastewater assets based on: receiving, from one or more weather measurement services, current environmental data comprising rainfall data associated with said each wastewater asset, the current environmental data affecting the flow of wastewater through said each wastewater asset; receiving, from the sensor of said each wastewater asset, real-time wastewater measurements associated with the wastewater flow at said each wastewater asset; applying the received current environmental data to a trained ML model configured for predicting, in real-time, minimum and maximum wastewater thresholds associated with wastewater flow through said each wastewater asset, wherein the ML model is trained to predict the minimum wastewater threshold using training data comprising time series minimum values of historical wastewater measurement data of said each wastewater asset given corresponding rainfall data as input, and the ML model is trained to predict the maximum wastewater threshold using training data comprising time series maximum values of historical wastewater measurement data of said each wastewater asset given corresponding rainfall data as input; detecting a downstream blockage anomaly at said each wastewater asset when one or more of multiple real-time wastewater measurements at said each wastewater asset at least exceeds the corresponding predicted maximum wastewater threshold for multiple contiguous time instances over an anomaly duration associated with downstream blockage; and detecting an upstream blockage anomaly at said each wastewater asset when one or more of multiple real-time wastewater measurements reaches below the corresponding predicted minimum wastewater threshold for multiple contiguous time instances over an anomaly duration associated with upstream blockage; and sending the indication of any detected blockages at each wastewater asset to the operator monitoring the wastewater network.

In a second aspect of this specification, there is disclosed an anomaly detection apparatus for detecting anomalies at one or more of a plurality of wastewater assets of a wastewater network, each the wastewater asset comprising a sensor configured for performing measurements associated with wastewater flow through said each wastewater asset waste, the anomaly detection apparatus comprising a ingestion unit, an machine learning unit, and an anomaly detection unit, the ingestion unit, ML unit and anomaly detection unit in communication with one or the other, wherein: the ingestion unit is configured for: receiving current environmental data comprising current rainfall data associated with each of the wastewater assets, the current environmental data affecting the flow of wastewater through each corresponding wastewater asset; receiving, from the sensor of each wastewater asset, real-time wastewater measurements associated with the wastewater flow at said each wastewater asset; processing each of the received real-time wastewater measurements to be synchronised with the corresponding received rainfall data associated with each corresponding wastewater asset; the ML unit configured for: training one or more ML models associated with each of the wastewater assets, each trained ML model for each wastewater asset configured for predicting, in real-time, minimum and maximum wastewater thresholds associated with wastewater flow through said each wastewater asset; and inputting the corresponding current received rainfall data to the trained ML model associated with each wastewater asset; outputting, from each ML model of each wastewater asset, data representative of predictions of the minimum and maximum wastewater thresholds associated with wastewater flow through said each wastewater asset; the anomaly detection unit configured for: for each wastewater asset, detecting an anomaly at said each wastewater asset when one or more of multiple real-time wastewater measurements at said each wastewater asset at least exceeds the corresponding predicted maximum wastewater threshold and/or reaches below the corresponding predicted minimum wastewater threshold over an anomaly duration associated with the anomaly; and in response to detecting an anomaly at said each wastewater asset, sending an indication of the detected anomaly to an operator monitoring the wastewater network.

As an option, the anomaly detection apparatus of the second aspect, wherein the ingestion unit, ML unit and anomaly detection unit are configured for implementing the corresponding steps of the computer-implemented method according to the first aspect and/or any of the features and/or options in relation to the first aspect.

In a third aspect of this specification, there is disclosed an apparatus comprising a processor and a memory connected together, the memory comprising computer instructions stored thereon which, when executed on the processor, causes the processor to perform the computer-implemented method according to the first aspect and/or any of the features and/or options in relation to the first aspect.

In a fourth aspect of this specification, there is disclosed a wastewater management system comprising: a wastewater network comprising a plurality of wastewater assets, wherein each wastewater asset comprises a sensor for measuring data representative of wastewater passing through said each wastewater asset; an anomaly detection apparatus according to the second aspect or operating according to the first aspect; wherein: the anomaly detection apparatus receives wastewater measurements from each of the sensors over a communication network; and the anomaly detection apparatus is configured for receiving over the communication network environmental data associated with each of the wastewater assets of the wastewater network.

In a fifth aspect of this specification, there is disclosed a computer-readable medium comprising data or instruction code, which when executed on a processor, causes the processor to implement the computer-implemented method of the first aspect and/or any of the features and/or options in relation to the first aspect.

In a sixth aspect of this specification, there is disclosed a machine learning model configured for predicting minimum and maximum wastewater thresholds for a wastewater asset of a wastewater network given rainfall data as input and obtained according to the computer-implemented method of the first aspect and/or any of the features and/or options in relation to the first aspect.

According to a seventh aspect of this specification, there is disclosed an apparatus comprising a processor, a memory unit and a communication interface, wherein the processor is connected to the memory unit and the communication interface, wherein processor and memory are configured to implement the computer-implemented method according to the first aspect and/or any of the features and/or options in relation to the first aspect.

According to an eighth aspect of this specification, there is disclosed a non-transitory tangible computer-readable medium comprising data or instruction code stored thereon, which when executed on one or more processor(s), causes at least one or more processor(s) to perform the steps of the method of detecting anomalies at a wastewater asset of a wastewater network, the wastewater asset comprising a sensor configured for performing measurements associated with wastewater flow through the wastewater asset, the method comprising: receiving current environmental data associated with the wastewater asset, the current environmental data comprising at least rainfall data associated with the wastewater asset; receiving, from the sensor of the wastewater asset, real-time wastewater measurements associated with the wastewater flow at the wastewater asset; applying the received current environmental data to a trained machine learning model configured for predicting, in real-time, minimum and maximum thresholds associated with wastewater flow through the wastewater asset; detecting an anomaly at the wastewater asset when one or more real-time wastewater measurements at the wastewater asset exceeds the corresponding predicted maximum wastewater threshold and/or reaches below the corresponding predicted minimum wastewater threshold over a time interval; and sending an indication of the detected anomaly at the wastewater asset to an operator monitoring the wastewater network.

### BRIEF DESCRIPTION OF THE DRAWINGS

Embodiments of the invention will be described, by way of example, with reference to the following drawings, in which:

FIG. 1a illustrates an example ML wastewater system 100 according to some embodiments of the invention;

FIG. 1b illustrates an example ML anomaly detection apparatus for detecting anomalies in wastewater system of FIG. 1a according to some embodiments of the invention;

FIG. 1c illustrates an example ML model for use in ML anomaly detection apparatus of FIG. 1a or 1b according to some embodiments of the invention;

FIG. 1d illustrates another example ML model for use in ML anomaly detection apparatus of FIG. 1a or 1b according to some embodiments of the invention;

FIG. 1e illustrates a further example ML model for use in ML anomaly detection apparatus of FIG. 1a or 1b according to some embodiments of the invention;

FIG. 2 illustrates an example data processing pipeline according to some embodiments of the invention;

FIG. 3 illustrates an example ML model training and generation process according to some embodiments of the invention;

FIG. 4 illustrates an example ML anomaly detection process according to some embodiments of the invention;

FIG. 5 illustrates an example histogram plot of wastewater measurement data according to some embodiments of the invention;

FIG. 6 illustrates another example histogram plot of wastewater measurement data according to some embodiments of the invention;

FIG. 7 illustrates an example exclusion event detection process according to some embodiments of the invention;

FIG. 8a illustrates an example hyper-local rainfall calculation diagram according to some embodiments of the invention;

FIGS. 8b-8e illustrates an example hyper-local rainfall calculation according to some embodiments of the invention;

FIG. 9 illustrates an example plot representing normal wastewater flow or level for a wastewater asset of a wastewater network according to some embodiments of the invention;

FIG. 10 illustrates an example plot representing a downstream blockage anomaly event being detected for a wastewater asset of a wastewater network according to some embodiments of the invention;

FIG. 11 illustrates another example plot representing a downstream blockage anomaly events being detected for a wastewater asset of a wastewater network according to some embodiments of the invention;

FIG. 12 illustrates an example plot of an upstream blockage anomaly event being detected for a wastewater asset of a wastewater network according to some embodiments of the invention;

FIG. 13a illustrates an example plot of a sensor anomaly event being detected for a wastewater asset of a wastewater network according to some embodiments of the invention;

FIG. 13b illustrates an example wastewater asset with debris interfering with a sensor resulting in the sensor anomaly event being detected in FIG. 13a according to some embodiments of the invention;

FIG. 14 illustrates a computing system according to some embodiments of the invention;

FIG. 15 illustrates a computer readable medium according to some embodiments of the invention.

Common reference numerals are used throughout the figures to indicate similar features.

### DETAILED DESCRIPTION

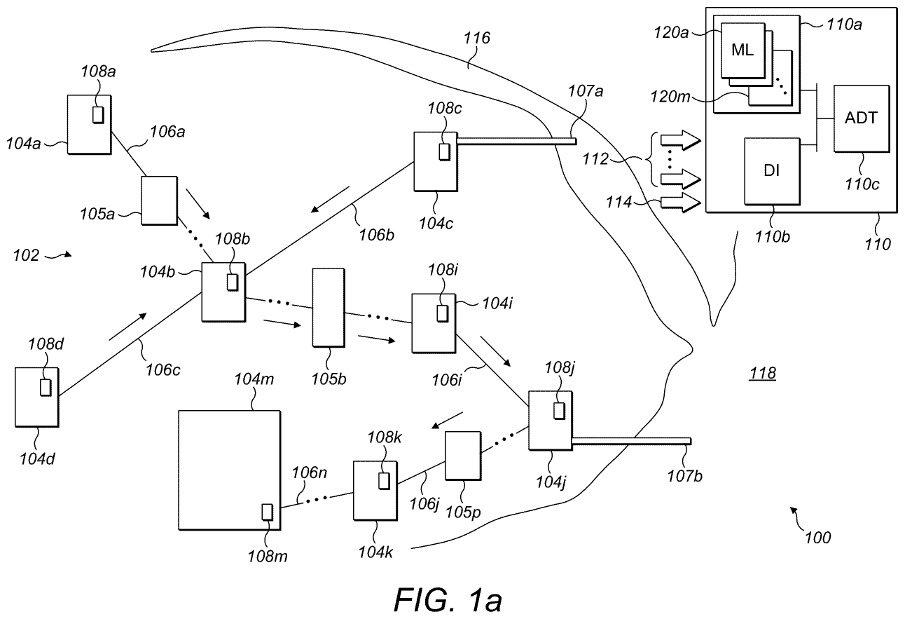

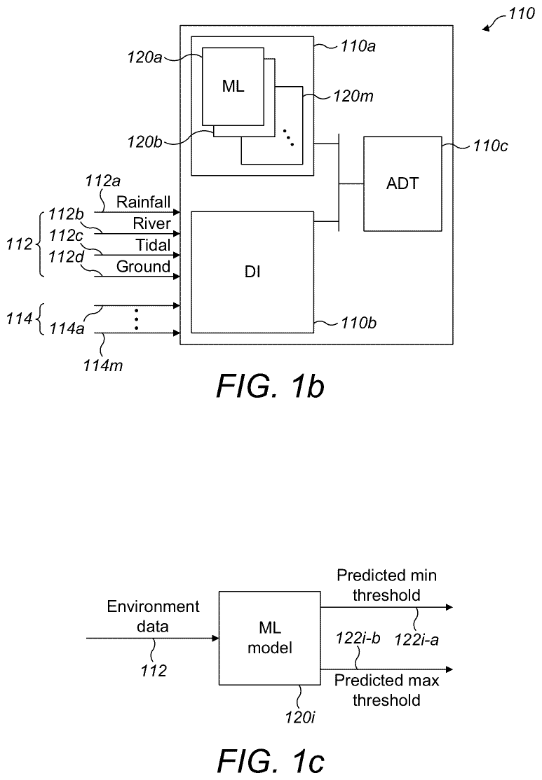

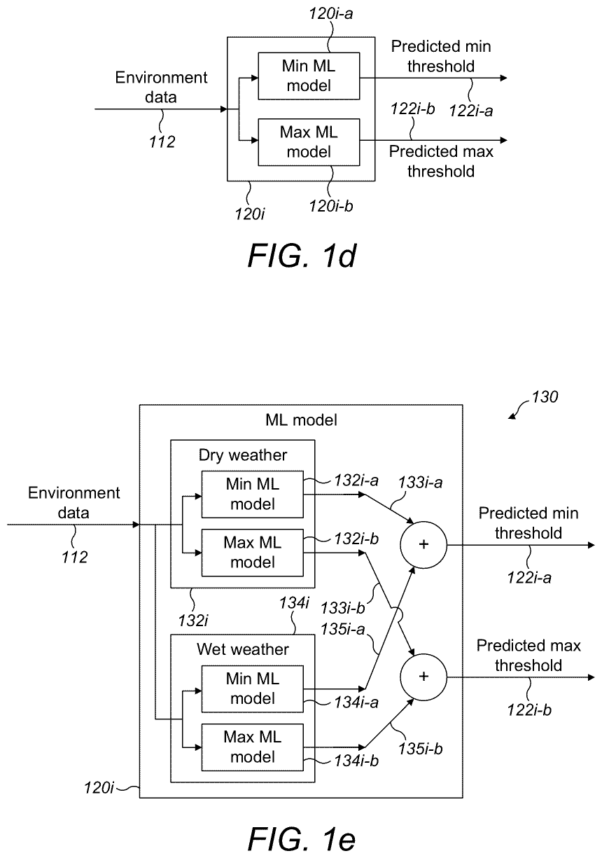

FIG. 1a illustrates an example machine learning (ML) wastewater management system 100 according to some embodiments of the invention. The ML wastewater management system 100 includes a wastewater network 102 including a plurality of wastewater assets 104a-104m and 105a-105p (also known as sewer assets or sites) connected together via wastewater pipes 106a-106n (also known as sewer/storm water pipes and/or drains), which form the wastewater network 102. The plurality of wastewater assets 104a-104m each include at least one sensor of a plurality of sensors 108a-108m. Not every wastewater asset in the wastewater network 102 is necessarily sensored, for example a group of wastewater assets 105a-105p of the plurality of wastewater assets 104a-104m and 105a-105p may be unsensored, where in this example, the group of wastewater assets 105a-105p of wastewater network 102 are shown to be unsensored. Although a group of wastewater assets 105a-105p are shown to be unsensored, this is by way of example only and the invention is not so limited, it is to be appreciated by the skilled person that wastewater network 102 may configured to include sensored and unsensored wastewater assets, or include wastewater assets that are all sensored as the application demands.

Each of the plurality of wastewater assets 104a-104m and 105a-105p are connected to one or more other of the plurality of wastewater assets 104a-104m and 105a-105p via one or more wastewater pipes 106a-106n. For example, wastewater asset 104a is connected to unsensored wastewater asset 105a via a wastewater pipe 106a, wastewater asset 104d is connected to wastewater asset 104b via a wastewater pipe 106c, wastewater asset 104c is connected to wastewater asset 104b via a wastewater pipe 106b, wastewater asset 104i is connected to another wastewater asset 104j via a wastewater pipe 106i, and so on. Although the wastewater network 102 has a plurality of sensored wastewater assets. In this example, each wastewater asset 104i of the plurality of wastewater assets 104a-104m includes at least one sensor 108i of the plurality of sensors 108a-108m, each sensor 108i of the corresponding wastewater asset 104i being configured to provide sensor measurements in relation to wastewater flowing through the corresponding wastewater asset 104i. The at least one sensor 108i of a wastewater asset 106i is configured for performing time series data measurements associated with wastewater flow (e.g. Sewer Level Measurement (SLM) data, Sewer Flow data, Sewer Flow Velocity Data), or an amount of wastewater, passing through the wastewater asset 104i. Each of the time series data measurements associated with wastewater flow produced by each sensor 108i may be timestamped and stored as historical wastewater flow measurements/data for use in training one or more ML models for predicting wastewater flows and the like. The wastewater network 102 further includes a ML wastewater anomaly detection apparatus 110 including a ML unit 110a, a data ingestion unit 110b, and an anomaly detection unit 110c connected together and configured for receiving and processing real-time environmental data 112 (e.g. rainfall, river levels, tidal levels, flood water levels, and/or ground water levels and the like) and a plurality of sensor measurements 114 from the sensors 108a-108m for performing real-time detection of wastewater asset anomalies such as, without limitation, for example blockages and/or sensor issues associated with wastewater network 102.

The ML wastewater anomaly detection apparatus 110 is configured to receive via data ingestion unit 110b data representative of at least: a) real-time wastewater measurements 114 associated with the wastewater flow from each of the sensors 108a-108n of wastewater assets 104a-104m, and b) current environmental data 112 associated with each of the wastewater assets 104a-104m. The current environmental data 112 may be timestamped and provided at regular time intervals (e.g. 5 minutes, 10 minutes, 15 minutes, 30minutes, hourly, and the like) and may include, without limitation, for example current rainfall data, river level data, groundwater level data, flood water level data, tidal data and the like. Each of the wastewater assets 104a-104n is associated with one of the corresponding trained ML models 120a-120m trained by ML unit 110a using training datasets based on historical time series timestamped environmental data (e.g. rainfall data, tidal data, ground water data, flood water level data, and/or river level data) and historical time series timestamped wastewater measurement data (or historical minimum, maximum, and/or mean time series timestamped wastewater measurement data derived from historical time series timestamped wastewater measurement data) from data ingestion unit 110b. Each trained ML model 120a is trained and configured for predicting, in real-time, minimum and maximum thresholds associated with the expected wastewater flow through the corresponding wastewater asset 104a based on applying the received current environmental data 112 (e.g. rainfall data) for the wastewater asset 104a to the trained ML model 120a. Thus, when applying the current environmental data 112 to the input of a trained ML model 120a of a wastewater asset 104a, the trained ML model 120a processes the current environmental data 112 associated with wastewater asset 104a and outputs a predicted maximum and minimum wastewater thresholds corresponding to the current real-time environmental data 112 associated with wastewater asset 104a. The detection unit 110c is configured for receiving the output predicted minimum and maximum thresholds for each of the wastewater assets 104a-104n and the corresponding real-time wastewater measurements 114 and detecting, for each of the wastewater assets 104a-104n, based on the received data whether an anomaly (e.g. blockage or sensor issue) occurs at one or more of the wastewater assets 104a-104n.

In this example, the wastewater network 102 receives wastewater comprising storm water, sewer water, and/or any other wastewater run-off from roads, land, farms, homes and/or business premises (not shown) that enter the via gutters and/or sewer/storm water drains (not shown) into the wastewater pipes 106a-106n of wastewater network 102. Each wastewater asset 104a-104k may be a manhole and/or human accessible section or site of the wastewater network 102 and/or a wastewater pumping station 108m for directing the wastewater via pipes 106a-106n to water treatment works for treatment. One or more of the wastewater assets 104c or 104j may have an overflow mechanism/pipe 107a or 107b to prevent wastewater from flooding out of one or more wastewater assets 104a-104m in the event of excessive wastewater flow caused by environmental events such as, without limitation, for example storms and/or excessive rainfall or manmade events such as, without limitation, for example burst drinking water mains/pipes and the like, where the wastewater may flood and contaminate land, homes, businesses, and the like. In this example, wastewater asset 104c has an overflow pipe 107a that allows overflow wastewater to exit the wastewater network 102 via a river 116 and wastewater asset 104j has an overflow pipe 107b that allows overflow wastewater to exit wastewater network 102 via the sea 118.

The overflow mechanisms/pipes 107a, 107b is only meant to be used in emergencies or extreme events where the wastewater network 102 may be overwhelmed. However, blockages and/or debris within the pipes 106a-106n and/or wastewater assets 104a-104m of the wastewater network may also cause the overflow mechanism 107a, 107b to be used to prevent any flooding of wastewater exiting above street level or out onto the land from the wastewater assets 104a-104m, which requires clean-up and treatment. The wastewater network 102 further includes a wastewater detection apparatus 110 configured for early detection of blockages, sensor errors for maintaining the wastewater network 102 and ensuring wastewater flow within the water network 102 is optimised to prevent and/or minimise the unnecessary use of overflow mechanisms 107a-107b and the like.

Each of the sensors 108a-108m may comprise or represent any type of sensor configured for measuring an amount or flow of wastewater at the corresponding wastewater asset. For example, a sensor may comprise at least one sensor from the group of: a wastewater level sensor; a wastewater flow sensor; a wastewater pressure sensor; a current pumping sensor; and/or any other sensor configured for performing measurements associated with the wastewater flow through a wastewater asset. An anomaly at a wastewater asset 104a may comprise or represent any type of abnormal behaviour of wastewater flow through the wastewater asset 104a. For example, an anomaly may comprise at least one or more anomalies from the group of: an upstream blockage; a downstream blockage; a measurement sensor fault or error; and/or any other issue or abnormal behaviour of wastewater flow associated with wastewater asset 104a. The measurement sensor fault or error may comprise or represent at least one from the group of: a sensor misalignment issue; a sensor calibration issue; a sensor communications issue; a sensor obstacle issue; and any other sensor fault, error or issue causing incorrect wastewater measurements being performed at the wastewater asset. The measurements 114 from the sensors 108a-108m of the wastewater assets 104a-104m may be communicated over a communication network (not shown) to the data ingestion unit 110b of anomaly detection apparatus 110 for processing and detection of whether one or more anomalies are occurring at one or more of the wastewater assets 104a-104m.

FIG. 1b illustrates the wastewater anomaly detection apparatus 110 according to some embodiments. The wastewater anomaly detection apparatus 110 includes ML unit 110a, data ingestion unit 110b, and anomaly detection unit 110c, which may be communicatively coupled together. The wastewater anomaly detection apparatus 110 may also be implemented using one or more processing units, memory and/or communication interfaces, which are connected together and configured to implement the functionality of ML unit 110a, data ingestion unit 110b, and anomaly detection unit 110c. The ML unit 110a is configured for using a plurality of trained ML models 120a-120m for predicting real-time wastewater minimum and maximum thresholds at each of the corresponding wastewater assets 104a-104m in response to a current environmental data instance 112 including, without limitation, for example one or more types of environmental data from the group of: a current rainfall data instance 112a, a current river level data instance 112b, a current tidal level data instance 1120, and current ground water level 112d etc. Each of the trained ML models 120a-120m may be trained on different combinations of the one or more types of historical environmental data instances 112a-112d and historical wastewater flow measurements/data (e.g., historical minimum, maximum and/or mean wastewater flow measurements/data) through the corresponding wastewater assets 104a-104m and the like depending on which combinations of environmental data 112a-112d affect each of the sites of the corresponding wastewater assets 104a-104m. For example, an ML model 120i may be trained by iteratively applying the historical environmental data as a training dataset to an ML algorithm configured to predict, in each iteration, minimum and maximum wastewater thresholds. In each iteration, these predictions are compared with corresponding historical minimum, maximum and/or mean wastewater measurement data, and the parameters/weights and the like of the ML algorithm is updated based on the comparison. This process is repeated until the predictions substantially match the corresponding historical wastewater measurement data (e.g. matching within an error threshold or maximum number of iterations is reached, etc.). The final updated ML algorithm may be used to form a trained ML model 120i configured for predicting wastewater minimum and maximum thresholds in relation to wastewater asset 104i.

The predicted wastewater minimum and maximum thresholds at each of the wastewater assets 104a-104m represents an estimate of the expected minimum and maximum wastewater flow through the wastewater asset 104i given the current environmental data instance 112 associated with that wastewater asset 104i. The predicted wastewater minimum and maximum thresholds may dynamically change over time and in relation to the environmental data ingestion instances (e.g. rainfall, ground water level, river level, flood water levels, and/or tidal levels and the like). With this in mind, the ML unit 110a is also configured for training and/or updating the plurality of ML models 120a-120m for each of the wastewater assets 104a-104m with each using training data instances based on historical environmental data (e.g. historical rainfall, groundwater levels, river levels, flood water levels, and/or tidal levels and the like) and historical wastewater measurements (e.g. historical minimum, maximum and mean wastewater measurements/data) from sensors 108a-108m associated with each of the corresponding wastewater assets 104a-104m.

As an example, the ML unit 110a may generate a trained ML model 120a for each wastewater asset 104a that is configured for predicting the minimum and maximum wastewater thresholds based on applying environmental data as input to the trained ML model 120a. Each of the trained ML models 120a-120m for each of the wastewater assets 104a-104m may be generated by performing a grid search or ML model search over a plurality of sets of hyperparameters used by the ML algorithm or process selected for training the model parameters (e.g. weights/coefficients) for the resulting ML model for that wastewater asset. Thus, multiple ML models may be generated for each wastewater asset 104a based on different sets of hyperparameters with the ML model resulting in a minimum error (e.g. root mean squared error (RMSE), mean square error (MSE) or other appropriate loss function) being be selected as the ML model 120a for that wastewater asset 104a.

The hyperparameters are those parameters, settings, coefficients used by the ML algorithm that are selected and set prior to training the model parameters that make up an ML model. Each set of hyperparameters may include, without limitation, for example: 1) the type of environmental data 112 that is to be input (e.g. rainfall, river levels, tidal levels, flood water levels, and/or ground water levels and the like) for each training instance; 2) a particular selected time windowing of the environmental data 112 for each training instance, the time window representing the amount of historical environmental data up to the present environmental data 112 used for that training instance, which will be input or applied to the ML algorithm used for training the model parameters of the ML model; and 3) depending on the type of ML algorithm (e.g. regression, neural network, and/or other ML algorithm) used for generating the ML model, the ML algorithm hyperparameters such as, without limitation, for example the base estimator, maximum number of estimators, train-test split ratio, learning rate in optimization algorithms (e.g. gradient descent, etc.), choice of optimization algorithm (e.g., gradient descent, stochastic gradient descent, or Adam optimizer, etc.), choice of activation function in a neural network (NN) layer (e.g. Sigmoid, ReLU, Tanh, etc.), choice of cost or loss function the model will use (e.g. RMSE, MSE, etc.), number of hidden layers in a NN, number of activation units in each layer, drop-out rate/probability in NN, number of iterations (epochs) in training, number of clusters in a clustering task, kernel or filter size in convolutional layers, pooling size, batch size, and/or any other parameter or value that is decided before training begins and whose values or configuration does not change when training ends.

Selecting an appropriate set of hyperparameters (or hyperparameter tuning) may be performed using various optimisation and search algorithms as is well known by a skilled person such as, without limitation, for example, grid search (e.g. testing all possible combinations of hyperparameters), randomized search (e.g. testing as many combinations of hyperparameters as possible), informed search (e.g. testing the most promising combinations of hyperparameters as possible), and/or evolutionary algorithms such as genetic algorithms (e.g. using evolution and natural selection concepts to select hyperparameters) and/or any other hyperparameter tuning algorithm as is well known by the skilled person. The resulting hyperparameters may be used for training the final ML model for a wastewater asset 104a and/or other ML models for that wastewater asset 104a.

FIG. 1c illustrates an example trained ML model 120i for wastewater asset 104i of wastewater network 102. In this case, the ML model 120i may have been trained to jointly predict the minimum and maximum wastewater thresholds 122i-a and 122i-b based on applying current environmental data 112 associated with wastewater asset 104i as input to the ML model 120i. The ML model 120i has been trained based on historical environmental training data instances and corresponding historical wastewater flow data (e.g., historical minimum, mean and maximum wastewater flow data) for predicting minimum and maximum wastewater thresholds 122i-a and 122i-b. The predicted minimum and maximum wastewater thresholds 122i-a and 122i-b may be passed to anomaly detection unit 110c for use in detecting whether an anomaly occurs at wastewater asset 104i. FIG. 1d illustrates another example trained ML model 120i for wastewater asset 104i of wastewater network 102. In this case, the ML model 120i may be built or formed from multiple ML models 120i-a and 120i-b in which each of the ML models 120i-a and 120i-b is trained separately to predict the minimum and maximum wastewater thresholds 122i-a and 122i-b, respectively, based on applying current environmental data 112 associated with wastewater asset 104i as input to the ML models 120i-a and 120i-b. The predicted minimum and maximum wastewater thresholds 122i-a and 122i-b may then be passed to anomaly detection unit 110c for use in detecting whether an anomaly occurs at

### Wastewater Asset 104i.

FIG. 1e illustrates a further example trained ML model system 130 that includes a further example trained ML model 120i for wastewater asset 104i of wastewater network 102. In this case, the ML model 120i may be built or formed from multiple ML models 132i and 134i, where ML model 132i is configured to be a dry weather ML model 132i and ML model 134i is configured to be a wet weather ML model 134i. The dry weather ML model 132i includes ML models 132i-a and 132i-b that have been trained separately on historical dry weather environmental training data instances and corresponding wastewater levels for predicting minimum and maximum dry weather wastewater thresholds 133i-a and 133i-b, respectively, based on current environmental data 112 associated with wastewater asset 104i as input. In this example, ML model 134i is a wet weather ML model 134i that includes ML models 134i-a and 134i-b that are trained separately on historical wet weather environmental data instances for predicting minimum and maximum wet weather wastewater thresholds 135i-a and 135i-b, respectively, based on current environmental data 112 associated with wastewater asset 104i as input.

The historical environmental data may be analysed to identify those portions of the historical environmental data that correspond with rainfall data indicating dry weather conditions, these identified dry weather portions may be extracted from the historical environmental data to form the historical dry weather environmental training data instances. The historical dry weather environmental training data instances along with corresponding historical wastewater measurements (e.g., historical minimum, mean and maximum dry weather wastewater flow data) may be used in training the ML models 132i-b and 132i-b. Similarly, the historical environmental data may be analysed to identify those portions of the historical environmental data that correspond with rainfall data excluding dry weather conditions, these identified wet weather portions may be extracted from the historical environmental data to form the historical wet weather environmental training data instances. The historical wet weather environmental training data instances along with corresponding historical wastewater measurements (e.g. historical minimum, mean and maximum wastewater flow data) may be used for training the ML models 134i-b and 134i-b.

The predicted minimum dry weather wastewater threshold 133i-a is combined with the predicted minimum wet weather wastewater threshold 135i-a to form the predicted minimum wastewater threshold 122i-a, which is output from ML model 120i. In this example, the predicted minimum dry weather wastewater threshold 133i-a is added to the predicted minimum wet weather wastewater threshold 135i-a to form the predicted minimum wastewater threshold 122i-a. The predicted maximum dry weather wastewater threshold 133i-b is combined with the predicted maximum wet weather wastewater threshold 135i-b to form the predicted maximum wastewater threshold 122i-b, which is output from ML model 122i. In this example, the predicted maximum dry weather wastewater threshold 133i-b is added to the predicted maximum wet weather wastewater threshold 135i-b to form the predicted maximum wastewater threshold 122i-b. The predicted minimum and maximum wastewater thresholds 122i-a and 122i-b may then be passed to anomaly detection unit 110c for use in detecting whether an anomaly occurs at wastewater asset 104i.

Although several ML model structures 120a-120m or 120i for a wastewater assets 104a-104m and/or 104i have been described with reference to FIGS. 1a-1e, this is by way of example only and the invention is not so limited, it is to be appreciated by the skilled person that any combination of ML model structures may be used to generate an ML model 120i for each wastewater asset 104i with at least one sensor 108i that is trained to predict minimum and maximum wastewater thresholds 122i-a and 122i-b from current environment data 112 associated with wastewater asset 104i. It is to be appreciated by the skilled person that each of the wastewater assets 104a-104m may have a corresponding ML model 120a-120m as described herein with reference to ML model 120i and wastewater asset 104i of FIGS. 1c-1e including various combinations thereof, modifications thereto, and/or as herein described and the like.

Examples of ML algorithms or processes that may be used include or may be based on, by way of example only but is not limited to, any ML algorithm or process that can train model parameters on a labelled and/or unlabelled time series datasets for generating a trained ML model that can track the behaviour of time series data for making predictions thereon. Some examples of ML algorithms may include or be based on, by way of example only but is not limited to, one or more ML algorithms associated with regression learning or ensemble meta-algorithms, Adaptive Boosting (AdaBoost), Gradient boosting, extreme Gradient boosting (XGBoost), bootstrap aggregating, CoBoost, BrownBoost, random forests, decision tree learning, association rule learning, data mining algorithms/methods, artificial neural networks (NNs), deep NNs, deep learning, deep learning ANNs, convolutional NNs, support vector machines (SVMs), one or more combinations thereof or modifications thereto and the like and/or any other suitable ML algorithm as the application demands.

For example, an ML model for wastewater asset 104i may be generated using an ML algorithm associated with regression learning or ensemble meta-algorithms, AdaBoost, Gradient boosting, extreme Gradient boosting and the like.

Such a chosen ML algorithm along with carefully selected hyperparameters such as, without limitation for example, the base estimator, maximum number of estimators, train-test split ratio, learning rate in optimization algorithms (e.g. gradient descent, etc.), choice of optimization algorithm and any other suitable hyperparameter may be used along with a training data set comprising data representative of historical wastewater measurement data 114a for wastewater asset 104i and corresponding environmental data associated with wastewater asset 104i to train model parameters for multiple ML models for a wastewater asset 104i. For example, an first ML model for predicting the mean wastewater measurement for each input current environment data instance received for wastewater asset 104i may be trained, a second ML model for predicting a minimum wastewater threshold for each input current environment data instance received for wastewater asset 104i may be trained, and/or a third ML model for predicting a maximum wastewater threshold for each input current environment data instance received for wastewater asset 104i may be trained.

The selection of the hyperparameters for the resulting ML model may be based on performing a hyperparameter grid search over a multiple hyperparameter ranges in which each of a plurality of first, second and/or third models for wastewater asset 104i are iteratively trained using the chosen ML algorithm for each of the combinations of the multiple hyperparameter ranges. The resulting plurality of trained first, second and/or third models are ranked against model performance statistics such as MSE, RMSE or other performance metrics, where the hyperparameters of the best performing model of the resulting plurality of models are selected. These selected hyperparameters can be used to train the second and third ML models for predicting minimum and maximum wastewater thresholds at wastewater asset 104i. Where the resulting trained ML model 120i for wastewater asset 104i comprises a second and third trained ML models 120i-a and 120i-b for predicting minimum and maximum wastewater thresholds 122i-a and 122i-b at wastewater asset 104i. This training methodology may be performed for each of the wastewater assets 104a-104m such that a trained ML model 120a-120m is generated for each of the wastewater assets 104a-104m.

Referring back to FIGS. 1a and 1b, the data ingestion unit 110b is configured for receiving environmental data instances 112 (e.g. current rainfall data, current ground water level data, current river level data, current tidal data) and real-time wastewater measurements 114a-114m from each of the corresponding wastewater assets 104a-104m. The data ingestion unit 110b includes a communication interface (CI) for receiving the environmental data 112 when it is available (e.g. periodic or aperiodic rainfall, ground water level, river level and/or tidal level measurements) and the real-time wastewater measurements 114a-114m from the sensors 108a-108m of each of the wastewater assets 104a-104m. This data is fed to the ML unit 110a and anomaly detection unit 110c as required.

At the ML unit 110a, each of the trained ML models 120a-120m of each of the wastewater assets 104a-104m processes the corresponding environmental data instances 112a-112d associated with each of the wastewater assets 104a-104m and outputs corresponding predicted wastewater minimum and maximum thresholds. For example, the trained ML model 120a of wastewater asset 104a outputs a predicted minimum and maximum thresholds as environmental data instances 112 are received associated with wastewater asset 104a. The predicted minimum and maximum thresholds for each of the wastewater assets 104a-104m are output to the anomaly detection unit 110c for detecting whether an anomaly occurs at one or more of the wastewater assets 104a-104m.

The anomaly detection unit 110c is configured for detecting, in real-time, whether an anomaly occurs at one or more of the wastewater assets 104a-104m based on the corresponding predicted wastewater minimum and maximum thresholds and the real-time measured wastewater measurements 114 at the wastewater assets 104a-104m. When the anomaly detection unit 110c detects whether an anomaly occurs at a wastewater asset 104a of the wastewater network 102 such as, for example, wastewater blockage and/or sensor faults and the like, the anomaly detection unit 110c sends a notification or alert to an operator apparatus or console for alerting an operator monitoring the wastewater network 102 of the anomaly. This provides the advantage of early scheduling and deployment of maintenance personnel for restoring or returning said wastewater asset 104a back to a normal behaviour (e.g. removing an upstream or downstream blockage, repairing a sensor and the like). Alternatively or additionally, the anomaly detection unit 110c may automatically communicate with a maintenance network/system for scheduling and deploying maintenance personnel for restoring or returning said wastewater asset 104a back to normal behaviour.

For each wastewater asset 104a, the anomaly detection unit 110c may perform an analysis that determines whether a particular anomaly occurs based on analysing whether the received one or more real-time wastewater measurements for a wastewater asset 104a exceeds the corresponding predicted maximum wastewater threshold and/or reaches below the corresponding predicted minimum wastewater threshold for that wastewater asset 104a over an anomaly detection time interval. In response to determining whether an anomaly occurs at one or more of the wastewater assets 104a-104n, the anomaly detection unit 110c sends an indication of the detected anomaly at said wastewater asset 104a to an operator monitoring the wastewater network 102.

For example, when an anomaly occurs in relation to a wastewater asset 104i, the wastewater measurements 114i from that wastewater asset 104i over a time interval corresponding to the anomaly may correlate to a particular wastewater pattern with respect to the wastewater measurements 114i, predicted maximum and/or minimum wastewater thresholds for that wastewater asset 104i. Detecting that an anomaly occurs may include the anomaly detection unit 110c comparing the data pattern created by the real-time wastewater measurements in relation to the predicted maximum or minimum thresholds over the time interval against a set of anomaly wastewater data patterns (or fingerprints), where each anomaly wastewater data pattern defines a specific type of anomaly.

For example, a downstream blockage anomaly data pattern may be based on the following pattern or behaviour. When the anomaly is a downstream blockage of the wastewater network downstream of the wastewater asset, then detecting a downstream blockage anomaly at a wastewater asset 104i of the wastewater network 102 may be based on analysing the wastewater measurements 114i received for the wastewater asset 104i and when the wastewater measurements 114i exceeds the predicted maximum wastewater thresholds for multiple contiguous time instances over the anomaly time interval, then determining a downstream blockage of the wastewater asset 104i has occurred. Once detected, the anomaly detection unit 110c may send an alert indicating that a downstream blockage anomaly has occurred at wastewater asset 104i.

For example, an upstream blockage anomaly data pattern may be based on the following pattern or behaviour. When the anomaly is an upstream blockage of the wastewater network 102 upstream of a wastewater asset 104i, then detecting an upstream blockage of the wastewater network 102 that is upstream of the wastewater asset 104i may be based on analysing the wastewater measurements 114i received for the wastewater asset 104i and when the wastewater measurements 114i are less than the predicted minimum wastewater thresholds for multiple contiguous time instances over the time interval, then determining an upstream blockage of the wastewater asset 104i. Once detected, the anomaly detection unit 110c may send an indication that an upstream blockage anomaly has occurred at wastewater asset 104i.

For example, a sensor anomaly data pattern may be based on the following patterns or behaviours. When the anomaly is a measurement sensor anomaly of a wastewater asset 104i, then detecting a measurement sensor anomaly when the wastewater measurements 114i oscillates between inside and outside the limits set by the maximum wastewater threshold or the minimum wastewater threshold over multiple contiguous time instances over the time interval. This may indicate the sensor is uncalibrated, misaligned (e.g. sensor is focusing on iron steps or other structural feature of the wastewater asset 104i rather than the wastewater flowing through the asset 104i), and/or there is an obstacle or debris obscuring or periodically obscuring the sensor's view of the wastewater flowing through the wastewater asset 104i. In another example, detecting the measurement sensor anomaly when the wastewater measurements regardless of rainfall are constant or zero for a predetermined interval of time corresponding to a sensor failure, communications failure, and/or misalignment of the sensor. The constant sensor reading may be inside the limits of the predicted maximum wastewater threshold or the minimum wastewater thresholds and/or outside the limits of the predicted maximum/minimum wastewater thresholds over the predetermined interval of time.

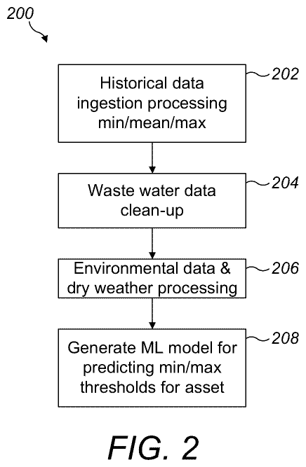

FIG. 2 illustrates a data cleaning pipeline process 200 for performing data clean-up and processing for use in generation of each of the trained ML models 120a-120m of ML wastewater management system 100. It is important to be able to train each of the ML models 120a-120m for predicting min/max wastewater thresholds 122i-a and 122i-b for each of the corresponding wastewater assets 104a-104m using individualised training data sets. An individualised training dataset for a wastewater asset 104i includes timestamped historical wastewater measurements 114i for that wastewater asset 104i and also corresponding timestamped historical environmental data 114i associated with that wastewater asset 104i. However, the raw historical wastewater measurements 114i from the sensor 108i of a wastewater asset 104i can include spurious or noisy data associated with, without limitation, for example sensor failure, misaligned sensors, uncalibrated sensors, change of sensors, blockages and other sensor or water asset anomalies and the like. In addition, raw historical wastewater measurements 114i may also have a higher time resolution with sensing time intervals/instances of the sensor 108i being in the region of 1 min or 5 min between sensing measurements as compared with environmental data 114i associated with the wastewater asset 104i in which environmental data instances may be received in the region of 10 min, 15 min, ½ hour, hourly, daily or weekly or typically any other time interval greater than that of the measurement sensor 108i.

Given this, the raw timestamped historical wastewater measurements 114i need to be normalised, cleaned (e.g. spurious data removed) and also synchronised in time with the timestamped environmental data associated with the wastewater asset 104i to ensure the resulting trained ML model 120i may track the normal behaviour of the wastewater asset 104i over time for predicting appropriate minimum and maximum wastewater thresholds in relation to a current environmental data instance for use in detecting anomalies of the water asset 104i. For each wastewater asset 104i of the plurality of wastewater asset 104a-104m, a data cleaning pipeline process 200 is performed to generate a training dataset for use in training the ML model 120i of said each wastewater asset 104i. The data cleaning pipeline process 200 may include the following steps of:

In operation 202, the historical wastewater measurements 114i from the sensor of the wastewater asset 104i is processed to:
a) normalise the magnitude of the historical wastewater measurements 114i to form normalised historical wastewater measurements (e.g. convert each wastewater measurement in the time series data to a percentage or fractional value between [0-1] or other appropriate value range based on the maximum and minimum measurement range the sensor 108i may be calibrated to perform); and
b) synchronise the time series normalised historical wastewater measurement data time resolution to the time resolution of a selected type of time series environmental data 112a-112d (e.g. rainfall data 112a). For example, for each time interval between environmental data instances of the selected type of environmental data 112a, generating a mean/max/minimum wastewater data instance for those normalised historical wastewater measurement data instances falling within the environmental data time interval to form a synchronised set of normalised historical wastewater instances, each instance having a mean, minimum and maximum normalised value for that time interval.

In operation 204, processing the synchronised set of normalised historical wastewater data instances to remove noisy data, spurious sensor measurements, blockages and the like and identify other events within the data based on:
a) identify, using statistical analysis, and remove outlier blocks of data from the synchronised set of normalised historical wastewater data instances. For example, a dispersion graph may be formed to identify the outlier blocks for removal. For example this may be performed based on performing statistical analysis on the synchronised set of normalised historical wastewater data instances such as, without limitation, for example generating a histogram of the synchronised set of normalised historical wastewater data instances for the wastewater asset 104i and identifying whether the statistical outlier blocks of the histogram data based on comparison with an idealised historical data pattern. The identified outlier blocks may be removed from the synchronised set of normalised historical wastewater data to form a first clean synchronised set of normalised historical wastewater data.
b) filter the first clean synchronised set of normalised historical wastewater data using long-term and short-term statistical averages and a ruleset for identifying inaccurate or discontinuity in the measurements. For example, null values between data instances may be interpolated or long series of null values may form a discontinuity for removal. This may form a second clean synchronised set of normalised historical wastewater data.
c) identify exclusion events from the second clean synchronised set of normalised historical wastewater data that affect the accuracy or continuity of the measurements from sensor 108i, such as, without limitation, for example: i) noisy data, spurious sensor measurements, blockages and the like; ii) rainfall events; iii) dry weather events; and/or iv) other feature events. Remove the noisy data, spurious sensor measurements, blockages and the like from the second clean synchronised set of normalised historical wastewater data to form a clean synchronised set of normalised historical wastewater data.
d) generating a dry weather dataset for the wastewater asset based on removing the portions of the clean synchronised set of normalised historical wastewater data associated with rainfall events from the clean synchronised set of normalised historical wastewater data to form the dry weather dataset. Alternatively or additionally, generating the dry weather dataset for the waste based on including those portions of the clean synchronised set of normalised historical wastewater data associated with dry weather events into the dry weather dataset. That is, the dry weather dataset comprises the clean synchronised set of normalised historical wastewater data excluding rainfall events and/or including dry weather events.

Should the synchronised set of normalised historical wastewater data instances include wastewater data instances within a predetermined time interval or time window that extends up to a certain time instance close to or at the current time instance where detection is sought, then when statistically analysing the synchronised set of normalised historical wastewater data instances, the histogram pattern may be also used to detect blockages and/or sensor faults occurring for the current time instance based any identified outliers in the histogram including normalised wastewater data instances within the predetermined time interval or time window. For example, a histogram may be generated of the synchronised set of normalised historical wastewater data instances for the wastewater asset 104i and identifying whether any statistical outlier blocks in the histogram data exist based on comparison with an idealised historical data pattern (e.g. a Gaussian or normal distribution pattern). If any outlier blocks of data are identified, then determining whether any of the normalised wastewater instances associated with the current time interval or time window are included in one or more of the outlier blocks. If this is the case, then one or more outlier blocks are associated with the current time window up to a current time instance, and analysis of these outlier blocks may be performed to determine and/or identify whether a sensor/wastewater asset anomaly (e.g. blockage, sensor fault) exists. For example, the type of sensor or wastewater asset anomaly may be identified based on the statistical pattern of the identified outlier blocks (e.g. iron bars, misalignment/calibration issue, communications issue etc.). Detecting the anomaly (e.g. sensor anomaly or wastewater asset anomaly) based on comparing the identified outlier blocks with one or more sensor or wastewater anomaly histogram patterns (e.g. iron step histogram pattern, sensor misalignment/calibration histogram pattern, blockage histogram pattern etc.) and finding a matching pattern, which identifies the type of anomaly. A notification or alert comprising data representative of detected and/or identified anomaly may be sent to a waste management monitoring system for scheduling maintenance, repair and/or further analysis of the wastewater measurements of the wastewater asset 104i.

In operation 206, updating environmental data instances to correspond to the clean synchronised set of normalised historical wastewater data instances by removing those environmental data instances that do not coincide with the timestamps of the clean synchronised set of normalised historical wastewater data instances. In addition, updating environmental data instances to correspond to the clean synchronised set of normalised historical wastewater data instances, may further include generating dry weather environmental data instances by including only those environmental data instances that coincide with the timestamps of corresponding synchronised set of normalised historical wastewater data instances contained within the dry weather dataset. Furthermore, the updated environmental data may include further processing various types of environmental data such as rainfall data 112a to estimate a more accurate or hyper-local rainfall dataset based on the location of the wastewater asset 104i within the area associated with the rainfall data and a plurality of other rainfall datasets from adjacent areas to the rainfall area the wastewater asset 104i is located within. For example, this may be based on performing a multivariate interpolation (e.g. three dimensional, tri-linear interpolation or nearest neighbour interpolation) to determine the hyper-local rainfall dataset at the location of the wastewater asset 104i based on the rainfall dataset covering the area the wastewater asset 104i is located in and other rainfall datasets associated with adjacent rainfall areas to the rainfall area the wastewater asset 104i is located within. In another example, the rainfall dataset for a wastewater asset 104i may be updated to a hyper-local rainfall dataset for said wastewater asset 104i based on identifying the three adjacent rainfall areas with the rainfall area the wastewater asset 104i located within that are closest to the wastewater asset 104i, and performing an interpolation and averaging process using the rainfall data of the identified three rainfall areas and the rainfall data of the rainfall area the wastewater asset 104i is located within to estimate a hyper-local rainfall dataset for wastewater asset 104i. Thus, the determined hyperlocal rainfall dataset for each wastewater asset 104i may be used in place of the rainfall dataset associated with the rainfall area said each wastewater asset 104i is located within. The updated environmental data instances may form a set of historical environmental training data instances. The dry weather environmental data instances may form a set of historical dry weather environmental training data instances.

The clean synchronised set of normalised historical wastewater data instances (which include normalised mean, min and max data instances) for a wastewater asset 104i and the updated environmental data instances (or set of historical environmental training data instances) form an individualised training dataset for the wastewater asset 104i. As an option, the dry weather dataset (which includes normalised mean, min and max data instances from the set of normalised historical wastewater data instances corresponding to dry weather) and the updated dry weather environmental data instances (or set of historical dry weather environmental data instances) form an individualised dry weather training dataset for the wastewater asset 104i.

In operation 208 generating a trained ML model 120i for the wastewater asset 104i to predict minimum and maximum thresholds for the wastewater asset based on: training model parameters using an ML algorithm (e.g. regression based algorithm) and the individualised training dataset for a wastewater asset 104i for a plurality of ML models by performing a hyperparameter grid search, where the model parameters for each ML model are trained by the ML algorithm for a particular set of hyperparameters for predicting mean, maximum and/or minimum wastewater thresholds based on the individualised training dataset for the wastewater asset 104i. The individualised training dataset for the wastewater asset 104i includes at least one of the mean data instances, maximum data instances, or minimum data instances of the cleaned synchronised set of normalised historical wastewater data instances and the corresponding updated environmental data instances.

Alternatively or additionally, generating the trained ML model 120i may further include training a wet weather ML model and training a dry weather ML model for the wastewater asset 104i to predict minimum and maximum thresholds for the wastewater asset 104i. The wet weather ML model may be trained based on: training model parameters using an ML algorithm (e.g. regression based algorithm) and the individualised training dataset for a wastewater asset 104i for a plurality of ML models by performing a hyperparameter grid search, where the model parameters for each ML model are trained by the ML algorithm for a particular set of hyperparameters for predicting mean, maximum and/or minimum wet weather wastewater thresholds based on the individualised training dataset for the wastewater asset 104i associated with rainfall/wet weather. The individualised training dataset for the wastewater asset 104i associated with rainfall/wet weather includes at least one of the mean data instances, maximum data instances, or minimum data instances of the cleaned synchronised set of normalised historical wastewater data instances and the corresponding updated environmental data instances (including rainfall). The dry weather ML model may be trained based on: training model parameters using an ML algorithm (e.g. regression based algorithm) and the individualised dry weather training dataset for the wastewater asset 104i for a plurality of ML models by performing a hyperparameter grid search, where the model parameters for each ML model are trained by the ML algorithm for a particular set of hyperparameters for predicting mean, maximum and/or minimum dry weather wastewater thresholds based on the individualised dry weather training dataset for the wastewater asset 104i. The individualised dry weather training dataset for the wastewater asset 104i includes data representative of the dry weather dataset (which includes normalised mean, minimum and maximum data instances from the set of normalised historical wastewater data instances corresponding to dry weather) and dry weather environmental data instances (or set of historical dry weather environmental data instances). The trained ML model 120i includes the trained dry weather ML model and trained wet weather ML model, where the minimum predicted wastewater threshold for the trained ML model 120i is formed based on a combination of the minimum predicted wet weather wastewater threshold and minimum predicted dry weather threshold, and the maximum predicted wastewater threshold for the trained ML model 120i is formed based on a combination of the maximum predicted wet weather wastewater threshold and maximum predicted dry weather threshold.

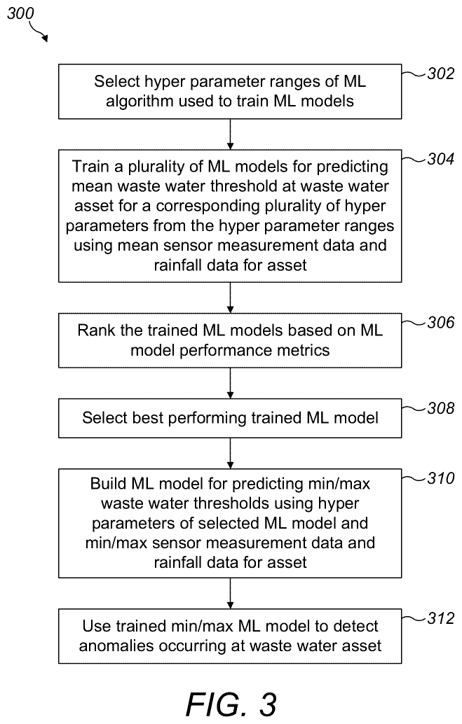

FIG. 3 illustrates a ML model generation process 300 for use in operation 208 of data processing pipeline 200 for building/generating an ML model 120i for the wastewater asset 104i that is capable of tracking and predicting the behaviour of wastewater flow through the wastewater asset 104i given environmental data as input to the ML model 120i. The ML model 120 is configured for predicting data representative of minimum and maximum wastewater thresholds for the wastewater asset 104i. It is assumed that the ML algorithm for training the model parameters of the ML model has already been chosen (e.g. regression, AdaBoost, Gradient Boost, extreme Gradient Boost and/or NN and the like). The ML model generation process 300 includes the following steps of:

In step 302, selecting a set of hyperparameter ranges for use with the ML algorithm for performing a hyperparameter grid search, where a plurality of ML models are trained over the various combinations of hyper parameters in the set of hyperparameter ranges.

In step 304, training model parameters for a plurality of ML models using the chosen ML algorithm and various combinations of hyperparameters of the set of hyperparameter ranges and the individualised training dataset for a wastewater asset 104i generated in operations 202-206. A hyperparameter grid search (or any other hyperparameter tuning algorithm) may be performed for generating by the ML algorithm model parameters for a plurality of ML models using all combinations of hyperparameters of the set of hyperparameter ranges. Each of the plurality of ML models may be trained to predict the mean, maximum and/or minimum wastewater thresholds based on the individualised training dataset for the wastewater asset 104i.

The individualised training dataset for the wastewater asset 104i includes at least one of the mean data instances, maximum data instances, or minimum data instances of the cleaned synchronised set of normalised historical wastewater data instances and the corresponding updated environmental data instances. It is noted that when the hyperparameter grid search is configured to try every combination of hyperparameters in the sets of hyperparameter ranges, this will result in the optimal combination of values for the hyperparameters that may be used to train the ML model 120i. Other hyperparameter tuning algorithms may be faster but at the expense of reducing the likelihood the optimal combination of hyperparameters is found for training the resulting ML model 120i. For the application of blockage detection, it is important to determine the optimal hyperparameters for use in training the ML model 120i, which should reduce inaccuracies in predicting data representative of the minimum and maximum wastewater thresholds, which can impact how rapidly blockages and other anomalies in the network are detected.

In step 306, ranking the plurality of trained ML models based on ML model performance statistics such as, without limitation, for example minimising RMSE and/or MSE or other ML performance metric. This orders the plurality of ML models according to ML model performance.

In step 308, selecting the best performing trained ML model from the ranked ML models based on minimising RMSE and/or MSE.

In step 310, building the final ML model 120i for predicting data representative of the minimum and/or maximum wastewater thresholds using the hyperparameters of the selected trained ML model and the minimum/maximum wastewater data instances and corresponding updated environmental data (e.g. rainfall data) for the wastewater asset 104. For example, the final ML model 120i may be built by using the hyperparameters of the selected trained ML model to form a first ML model 120i-a for predicting the data representative of the current minimum wastewater threshold when given a current environmental data instance (e.g. current rainfall) as input, and a second ML model 120i-b for predicting data representative of the maximum wastewater threshold when given an current environmental data instance (e.g. current rainfall) as input. The final ML model 120i for the wastewater asset 104i comprising the first and second ML models is configured to predict current minimum and maximum wastewater thresholds 122i-a and 122i-b when given a current environmental data instance (e.g. rainfall).

In step 312, the final trained ML model 120i for wastewater asset 104i is used to predict data representative of current minimum and maximum wastewater thresholds for the wastewater asset 104i when current environmental data (e.g. rainfall) is input. The predicted data representative of the current minimum and maximum wastewater are collected over time by the anomaly detection unit 110c and added into a time series of predicted minimum and maximum wastewater thresholds for use in detecting anomalies by comparing patterns of data representative of a time series of current wastewater measurements 114i with the corresponding time series of predicted minimum and maximum wastewater thresholds for wastewater asset 104i.

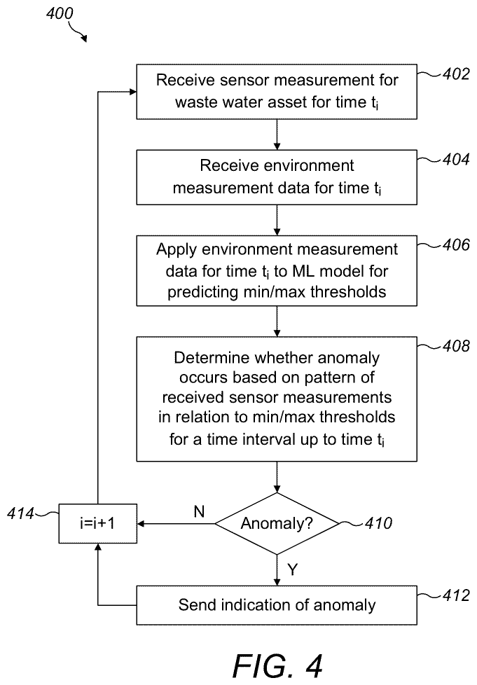

FIG. 4 illustrates an anomaly detection process 400 for use in anomaly detection unit 110c and/or step 312 of ML model generation process 300 for detecting whether and/or when an anomaly occurs at wastewater asset 104i of wastewater network 102. The anomaly detection process 400 may be used for each of the wastewater assets 104a-104m for detecting anomalies at each of those wastewater assets 104a-104m. The ML model 120i of wastewater asset 104i has been trained to predict data representative of minimum and maximum wastewater thresholds for the wastewater asset 104i given a current environmental data that is input for a particular time instance. The anomaly detection process 400 includes the following steps of:

In step 402, receiving sensor wastewater measurements 114i for wastewater asset 104i over time.

In step 404, receiving an environmental measurement data (e.g. rainfall data) at an i-th time instance.

In step 406, applying the received environmental measurement data for the i-th time instance to ML model 120i for predicting data representative of minimum and maximum wastewater thresholds for the wastewater asset 104i for at least the (i+1)-th time instance in the future.

In step 408, determining whether an anomaly occurs at wastewater asset 104i based on pattern of a collected time series of received sensor wastewater measurements 114i in relation to a collected time series of previous predicted minimum and maximum wastewater thresholds and the predicted minimum and maximum wastewater thresholds for the (i+1)-th time instance of the wastewater asset 104i.

In step 410, checking whether an anomaly has occurred, if an anomaly has occurred (e.g. Y), the proceed to step 412 otherwise (e.g. N) proceed to step 414.

In step 412, sending an indication or alert of the detected anomaly at wastewater asset 104i to wastewater management system 100 for arranging maintenance and/or repair of wastewater asset 104i.

In step 414, proceeding to the next (i+1)-th time instance and step 402 for receiving sensor measurement data from wastewater asset 104i over time until the (i+1)-th time instance.

Referring to FIGS. 1a to 1e, 2, 3 and/or 4, an example embodiment of the ML water management system 100, ML anomaly detection apparatus 110, ML models 120a-120m and data processing pipeline 200, ML generation process 300 and detection process 400 are now described with respect to the sensors 108a-108i being configured to measure wastewater levels (e.g. sewer levels measurements). Although this example embodiment describes the specifics of using sensors 108a-108i of sensing wastewater levels, this is by way of example only and the invention is not so limited, it is to be appreciated by the skilled person that the following example embodiment may be applied to any other type of sensor that may be used in one or more other wastewater assets 104a-104m such as, without limitation, for example flow meters, temperature sensors, pressure sensors, current sensors or power sensors related to pumps within wastewater network 102, and/or other monitors/sensors that have output analogue data and/or any other sensor and the like as the application demands.

Operation 202 of pipeline process 200 may be performed, where wastewater measurement data 114 that is ingested by data ingestion unit 110b is a time series sensor data stream that is received from sensors 108a-108i in wastewater assets 104a-104m of wastewater/storm water network 102. The wastewater measurement data may be a historical time series data set and/or current real-time wastewater measurement dataset, where the following is applicable to both. In this example, the sensors 108a-108m are level or flow sensors. Each time series data stream comprises wastewater level or flow measurement data and time stamps for each measurement.

The sensors 108a-108m may be measuring the wastewater levels or flows at a first time resolution such as, without limitation, for example once every 1, 2, 5, or 10 minutes and/or any other appropriate time period of N units of time (e.g. minutes). The wastewater measurement data 114 may first be normalised to represent a capacity of the wastewater asset 104i as a percentage or a fractional number in the range [0,1], and/or any other value. This may be performed for each wastewater measurement data 114i from each sensor 108i by determining the minimum measurement and maximum measurement the sensor 108i may be calibrated to perform and then normalising each wastewater measurement data 114i based on the minimum/maximum measurements of the corresponding sensor 108i. For example, the wastewater sensor measurement data may be provided in units of cm, where the sensor 108i where metadata in the sensor reading may provide the invert bottom as o and top or max sensor reading as 5 metres, which may be used to translate the measured levels into a percentage. If the sensor pre-processes or normalises the sensor data, then normalisation is not necessary, but in other situations when the sensor data is simply provided as an analogue reading then the normalisation processing is performed on the wastewater measurement data 114i at data ingestion unit 110b prior to processing, training, and/or detection of anomalies.

For example, training of the ML models 120i may be performed using the capacity percentages, where the data that is ingested is normalised and converted to a percentage based on, for example, empty level of the wastewater asset 104i and full level of wastewater asset. These may be used to convert the ingested wastewater measurements 114i into a capacity percentage (%). Although capacity percentage is used herein, this is by way of example only and the invention is not so limited, it is to be appreciated by the skilled person that the wastewater measurement data 114i from each wastewater asset 104i may be normalised in any other manner and the like as the application demands.

Once the wastewater measurement data 114i from sensor 108i of wastewater asset 104i is ingested and normalised, it may be processed and segmented or synchronised into a second time resolution such as, for example, 15, 20, 30 minute, hourly, daily periods and/or any other appropriate time period of M units of time (e.g. minutes), where the time period N may be smaller than the time period M. Time period M may coincide with the time period resolution of the time series environmental data associated with wastewater asset 104i. Thus, the time series normalised wastewater measurement data 114i may be synchronised in time with the time series environmental data. In this example, the environmental data 112 includes rainfall data 112a and the time period M is set to the time period resolution that rainfall data 112a is received and ingested by data ingestion unit 110b. This may be dictated by an external operator such as the weather office/organisations rainfall measurement services. For example, rainfall data may be provided at 15 minute periods, so time period M may be set to 15 minute periods. Given this, the normalised wastewater measurement data 114i from sensor 108i is segmented into M time periods (e.g. 15 minute periods) by calculating from the ingested normalised wastewater measurement data 114i the maximum, mean (e.g. average) and minimum level or flow reading over each time period M (e.g. each 15 minute period). Thus a synchronised normalised wastewater measurement dataset is formed for wastewater asset 104i that includes three different time series wastewater measurement datasets comprising maximum, minimum and mean wastewater measurement levels or flows over each time period M.

Operation 204 of pipeline process 200 may be performed, where the synchronised normalised wastewater measurement dataset is processed and cleaned-up to ensure the best correlation and learning may be achieved by the ML model 120i of the wastewater asset 104i, which further improves the predictions and the like.

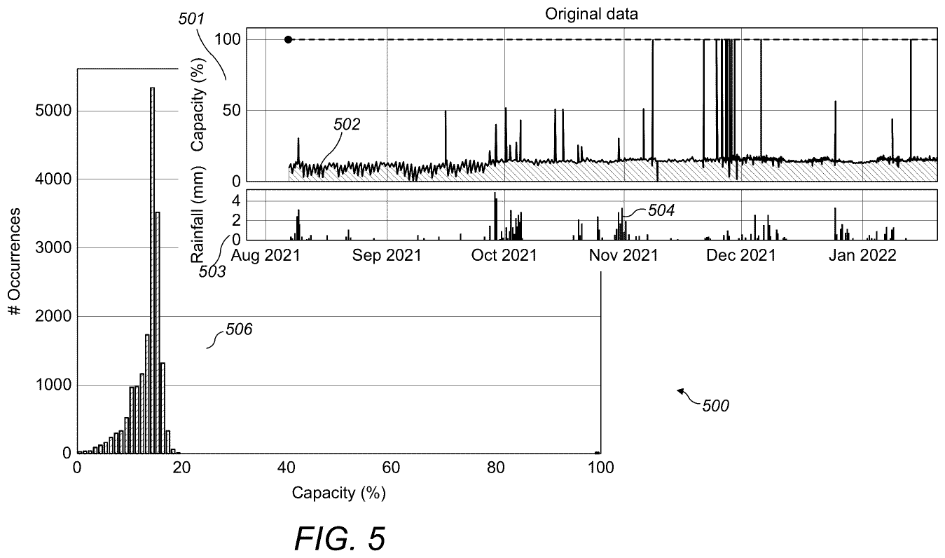

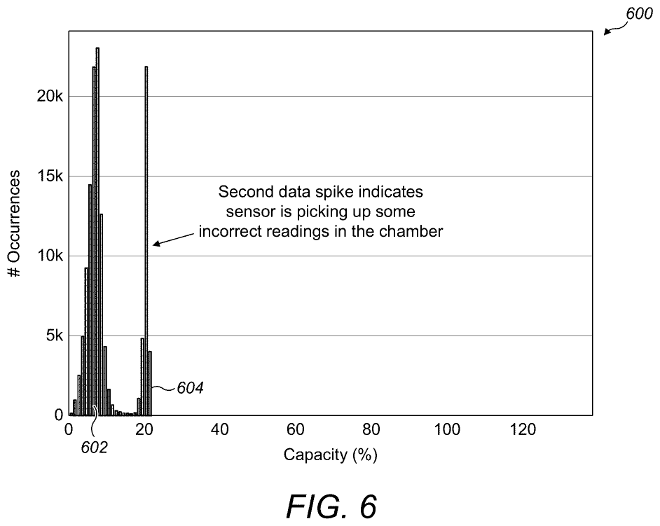

Essentially, this process and clean-up of data eliminates incorrect data and/or impossible types data from the synchronised normalised wastewater measurement dataset. The clean-up processes may be performed on the synchronised normalised wastewater measurement dataset for wastewater asset 104i based on the following sequence of events: Item 1) identify and remove outlier blocks of data from the synchronised normalised wastewater measurement dataset is formed for wastewater asset 104i using a dispersion graph (e.g. FIGS. 5 and 6); Item 2) filter the remaining data of the synchronised normalised wastewater measurement dataset is formed for wastewater asset 104i; Item 3) identify exclusion events that affect the accuracy or continuity of the measurements from sensor 108i, blockages and the like; and Item 4) forming a dry weather dataset based on those portions of the cleaned synchronised normalised wastewater measurement dataset corresponding to dry weather events (or excluding rainfall events). The cleaned synchronised normalised wastewater measurement dataset and corresponding environmental data and/or dry weather dataset may be used to form individualised training datasets for use in performing ML to generate and build the trained ML model 120i for predicting data representative of minimum and maximum wastewater thresholds for wastewater asset 104i when given a current environment data instance (e.g. current rainfall data in relation to wastewater asset 104i) as input.

For example, Item 1) of the clean-up process may be configured to plot the mean values of the synchronised normalised wastewater measurement dataset on a dispersion graph for determining the normal dispersion of the wastewater asset 104i, where any blocks or portions of data that are widely outside (or are outliers) of the normal dispersion are removed from the synchronised normalised wastewater measurement dataset. In this example, as the dispersion graph is used to identify blocks of the mean values of synchronised normalised wastewater measurement dataset that are outliers, the corresponding blocks of maximum and minimum values of synchronised normalised wastewater measurement dataset are also removed. An example dispersion graph is illustrated in FIG. 5.

FIG. 5 illustrates a histogram dispersion graph 500 for an example synchronised normalised wastewater measurement dataset 502 (e.g. original data) for 6 months of sensor level measurements in which the mean values of the synchronised normalised wastewater measurement dataset are shown above rainfall data 504 (rainfall in mm). The synchronised normalised wastewater measurement dataset 502 is illustrated on a capacity plot 501 with the y-axis being a capacity percentage of the wastewater asset 104i and is plotted at 15 minute intervals along the x-axis over a 6 month period from August 2021 to January 2022. The rainfall data 504 is illustrated below on a rainfall plot 503 with the y-axis in mm of rainfall for every 15 minute interval, and rainfall is plotted at 15 minute intervals along the x-axis over the 6 month period from August 2021 to January 2022. The histogram dispersion graph 506 plots bins representing the number of occurrences of the synchronised normalised wastewater measurement dataset 502 on the y-axis and the capacity percentage (Capacity (%)) of each occurrence bin along the x-axis. As can be seen, the histogram dispersion graph indicates the majority of data sits at around 16-18 % capacity and falls away cleanly either side the 16-18% capacity with no outlier blocks or bins of data.

FIG. 6 illustrates a histogram dispersion graph 600 for another example of synchronised normalised wastewater measurement dataset that has outlier blocks of measurements. The histogram dispersion graph 602 plots bins representing the number of occurrences of the example synchronised normalised wastewater measurement dataset on the y-axis and the capacity percentage (Capacity (%)) of each occurrence bin along the x-axis. As can be seen, the histogram dispersion graph indicates the majority of data 602 sits at around 6-8 % capacity and falls away cleanly either side the 6-8% capacity but has a second spike of bins representing one or more outlier blocks or bins of data 604 around the 20% capacity. These identified outlier blocks 604 indicate the sensor 108i is picking up incorrect sensor readings within the chamber of the wastewater asset 104i for the periods of time of the time series data associated with the data within these bins.

Outlier blocks in the synchronised normalised wastewater measurement dataset may occur based on phenomena within the location of the wastewater asset 104i of the wastewater network 102 (also referred to as storm water or sewer network). For example, the sensor 108i may measure something else in the wastewater asset 104i other than data representative of the wastewater levels or flow of wastewater passing through wastewater asset 104i that it should not be measuring. Phenomena that the sensor 108i should not be measuring, but may do so due to misalignment or debris in the wastewater asset 104i include, without limitation, for example iron steps/metal steps within the wastewater asset 104i allowing maintenance crew ingress/egress from the asset, the sensor beam may pick-up the side walls of the asset or other structural element of the asset 104i (e.g. some concreate obstacle inside the chamber where measurement is taking place), or even debris stuck in the wastewater asset 104i in the path of the sensor beam and the like. These phenomena typically show up on the histogram dispersion graph as outlier blocks of data above and below the tails of the normal histogram dispersion graph shape. Thus, if there are data blocks or histogram bins outside the normal distribution range of the dispersion graph for the wastewater asset 104i, then these blocks of data or histogram bins are identified as outlier blocks, where the corresponding mean, maximum and minimum value blocks of the synchronised normalised wastewater measurement dataset are removed from the time series dataset.

Thus, identified outlier blocks are removed from the synchronised normalised wastewater measurement dataset to form a first cleaned synchronised normalised wastewater measurement dataset, where the corresponding mean, maximum and minimum value blocks of the synchronised normalised wastewater measurement dataset have been removed.

An example of performing Item 2) comprises filtering the first cleaned wastewater measurement dataset output from Item 1) based on performing statistical analysis and filtering the dataset to remove periods of null data, periods of impossible data and the like. This is because each sensor 108i may provide sensor readings that are not plausible, but which may not have been identified as outliers in item 1). Sets of rules may be used to determine which pieces of data are plausible and not plausible, and which of the determine pieces of data may be modified and/or removed. For example, in some cases implausible readings between plausible readings (e.g. high impossible levels or Null data e.g. 0) may be modified by imputing or interpolating the implausible data based on data values around the implausible data value in the time series dataset. For example, interpolate between a previous and a next measurement data value in the time series dataset, the implausible data value is an isolated incident, but not if there is a prolonged period of implausible data values within the time series dataset, which may instead be removed. Although capacity is given as a percentage, which is greater than or equal to 0, negative values may occur due to the sensor not being calibrated, thus negative data may be removed, and/or the entire dataset may be shifted and renormalized to remove negative data. Various rules may be defined for removing such sensor data. Thus, the first cleaned synchronised normalised wastewater measurement dataset may be analysed and filtered to remove implausible values in the first cleaned synchronised normalised wastewater measurement dataset to form a second cleaned synchronised normalised wastewater measurement dataset.

An example of performing Item 3) comprises identifying within the second cleaned synchronised normalised wastewater measurement dataset exclusion events that affect the accuracy or continuity of the measurements from sensor 108i, e.g. blockages, sensor changes, wastewater asset 104i cleaning and the like. Various phenomena may occur within the wastewater assets 104a-104m of wastewater network 102, in which they can occasionally get cleaned out (e.g. jetting) and dirt is cleaned from sewer and/or wastewater asset 104i. This may mean that the chord level starts from a different point lowering the wastewater level in one or more wastewater assets 104a-104m. Other phenomena include, without limitation, for example broken sensors, sensors being replaced with sensors having different calibration or even different type of sensor within the wastewater measurement dataset, changes to a pump set in which a portion of the wastewater network 102 (e.g. sewer) operates differently and/or any other phenomena that causes periods of the measurement data to be inconsistent with the remaining periods of the measurement data. These phenomena are classed as exclusion events and are identified and removed from the second cleaned synchronised normalised wastewater measurement dataset. These are exclusion events or periods may be labelled and removed from the second cleaned synchronised normalised wastewater measurement dataset. The labelling may be performed to enable a second manual check to be performed, should this be necessary.

A set of rules may be defined for identifying exclusion events, which are periods of time that are inconsistent with the rest of the measurement data, which are then labelled as exclusion events. For example, rules may be determined based on analysing daily and weekly mean levels on a rolling basis and identifying periods where the daily and weekly mean values sit outside the normal ranges. These periods may be identified as exclusion periods and used to form the set of rules identifying exclusion events for that particular wastewater asset.

The data covered by each exclusion event is removed from the dataset going forward. The exclusion event processing may include performing statistical analysis on the second cleaned synchronised normalised wastewater measurement dataset including, without limitation, for example defining various different exclusion rules that analyse statistics including averages per day, maximums and/or minimums per day, averaging statistics across one or more weeks, one or more months one or more years, to identify periods of time that are inconsistent with the regular hourly mean, daily mean, weekly mean, yearly mean and the like.

Exclusion rules may further include rules that are configured to identify non-consistent periods of data much longer than previous stage in the sequence, e.g. months at a time where that wastewater asset 104i/sensor 108i was being serviced, or some reason a different sensor is being used, where earlier data before the new or serviced sensor is labelled as an exclusion event and is not generally usable due to different calibration or different sensor etc. Thus, the exclusion rules and statistical analysis is used to identify exclusion events and remove these from the second cleaned synchronised normalised wastewater measurement dataset to form the cleaned synchronised normalised wastewater measurement dataset. Typically, exclusion processing analyses the most recent second cleaned synchronised normalised wastewater measurement dataset first and then moves backwards in the time series dataset to identify any regular patterns and whether these regular patterns are associated with exclusion events based on the statistical analysis and exclusion rules.

This exclusion event processing is performed so that the ML model 120i is trained to track the normal wastewater level or flow behaviour through wastewater asset 104i rather than blockages or other exclusion events. Given this, wastewater measurement data typically can have some exclusion events/periods such as blockages for a few days or weeks, sensor recalibration, identified parts of data that are not consistent with what sensor 108i and wastewater asset 104i has been operating for the majority of its service time, and/or other exclusion events or periods. The exclusion event processing identifies and removes exclusion events/periods from the second cleaned synchronised normalised wastewater measurement dataset to form the cleaned synchronised normalised wastewater measurement dataset, which includes the remaining mean, minimum and maximum values after having those mean, minimum and maximum values removed during the sequence of processes of Items 1), 2) and 3).

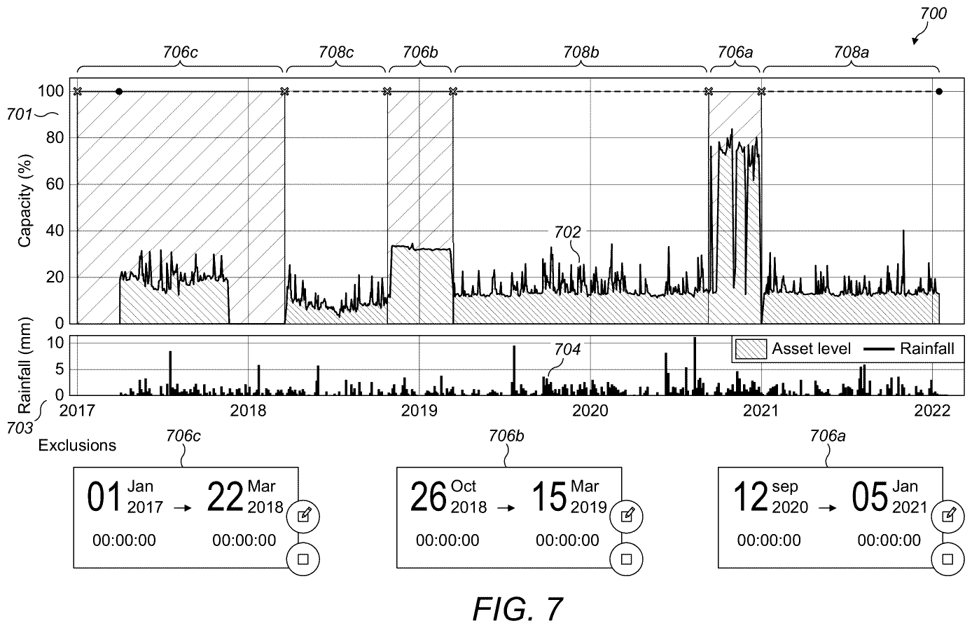

FIG. 7 illustrates plots 700 of an example second cleaned synchronised normalised wastewater measurement dataset 702 for a wastewater asset 104i and also a rainfall dataset 704 associated with the wastewater asset 104i prior to exclusion event processing. The second cleaned synchronised normalised wastewater measurement dataset 702 is illustrated on a capacity plot 701 with the y-axis being a capacity percentage of the wastewater asset 104i and is plotted at 15 minute intervals along the x-axis over a 5 year period between Jan 2017 to Jan 2022. The rainfall data 704 is illustrated below on a rainfall plot 703 with the y-axis in mm of rainfall for every 15 minute interval, and rainfall is plotted at 15 minute intervals along the x-axis over the 6 month period between Jan 2017 to Jan 2022.

The exclusion event process is performed by analysing the example second cleaned synchronised normalised wastewater measurement dataset 702 for the wastewater asset 104i from the most recent data and going backwards in time for identifying, based on the exclusion rules, which portions of the time series dataset is a regular pattern and hence an exclusion event 706a, 706b, 706c and which portions of the time series dataset are not a regular pattern or do not fit the exclusion rules and is likely data that exhibits normal sensor behaviour 708a, 708b, 708c. In this example, exclusion events/periods 706a, 706b and 706c have been identified by the exclusion processing for the time periods. The exclusion event/period 706a for 12 Sep. 2020 to 5 Jan. 2021 in which the time series data 702 exhibit a blockage exclusion pattern occurring. The exclusion event/period 706b for 26 Oct. 2018 to 15 Mar. 2019 in which the time series data 702 exhibits a changed sensor for a period of time or minor blockage exclusion pattern. The exclusion event/period 706c for 1 Jan. 2017-22 Mar. 2022 exhibits a sensor failure and new sensor being inserted type exclusion pattern. Thus, in this example, the identified exclusion events/periods 706a, 706b and 706c in the data of the example second cleaned synchronised normalised wastewater measurement dataset 702 are removed to form a cleaned synchronised normalised wastewater measurement dataset, which includes the remaining mean, minimum and maximum values after having those mean, minimum and maximum values of the exclusion periods 708a, 708b and 708c removed.

As an example of performing Item 4), once the cleaned synchronised normalised wastewater measurement dataset of the sensor 108i for the wastewater asset 104i has been determined, a dry weather flow dataset for wastewater asset 104i may be determined from the corresponding cleaned synchronised normalised wastewater measurement dataset. This may also be performed by the data ingestion unit 110b. The dry weather flow dataset for wastewater asset 104i is determined by removing from the cleaned synchronised normalised wastewater measurement dataset, which is timestamped, every day's worth of data when it is raining, and also zero, one, two, three or R days after rain depending on the behaviour of the wastewater asset 104i, where R may be chosen depending on how rainfall affects the flow of wastewater through asset 104i and may continue for 0, 1, 2 or R days after the rainfall until the wastewater flow subsides to what is considered a normal dry weather flow for that wastewater asset 104i. This takes into account delayed sensor readings where rainfall rained but the rain is still going through the wastewater network 102, 1, 2, 3 or R days after the rainfall. The value R may be statistically and/or empirically determined and/or manually changed. The resulting dataset with is called the dry weather dataset for the wastewater asset 104i, where only the mean, minimum and maximum levels or flow for days when there is no rain affecting the wastewater asset 104i of the wastewater network 102. Dry weather dataset may be used to train a dry weather ML model for predicting/calculating minimum and maximum wastewater flows during periods of dry weather. The dry weather ML model may be used as the dry weather ML model 132i in the ML model system 130 of FIG. 1e.

Alternatively or additionally, the dry weather dataset for wastewater asset 104i may be further processed into an average dry flow dataset for each day of the week (e.g. Monday, Tuesday, Wednesday, Thursday, Friday, Saturday, and Sunday) is calculated, in which the mean values of the dry weather dataset for each of the same days of the week over the dry weather dataset are averaged at each of the M interval time units for that day, where in this example, M=15 minutes. This builds an average dry weather profile for an average week for every day. Thus, all of the Mondays in the dry weather datasets gets added together at every M time interval (e.g. 15 minute period) and averaged, similarly for all of the Tuesdays, Wednesdays, Thursdays, Fridays, Saturdays, and Sundays.

The dry weather profile for every day of an average week may be further optimised by analysing the dry weather patterns over the dry weather dataset and selecting the best weeks and/or months, and only performing the above averaging process in which the mean values of the dry weather dataset for each of the same days of the week over only the best weeks/months of the dry weather dataset are averaged at each of the M interval time units for that day, where in this example, M=15 minutes.

Dry weather profile for every day of an average week may form another type of dry weather dataset that can also be used to train a dry weather ML model for predicting/calculating minimum and maximum wastewater flows during periods of dry weather. The dry weather ML model may be used as the dry weather ML model 132i in the ML model system 130 of FIG. 1e.

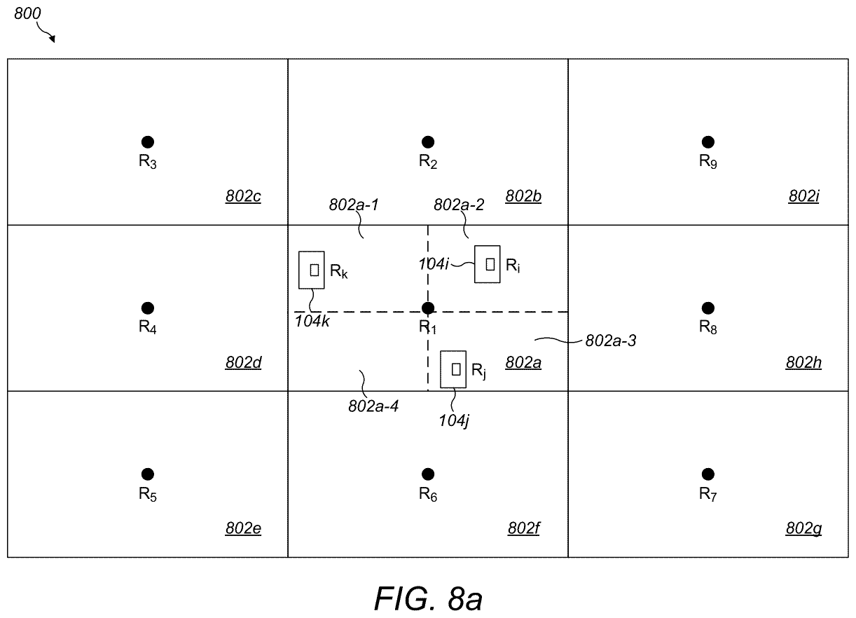

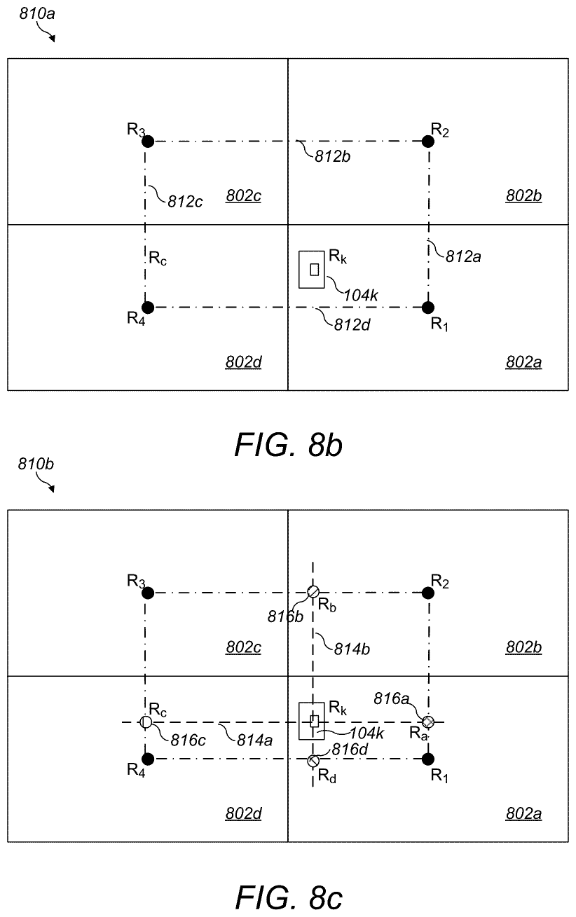

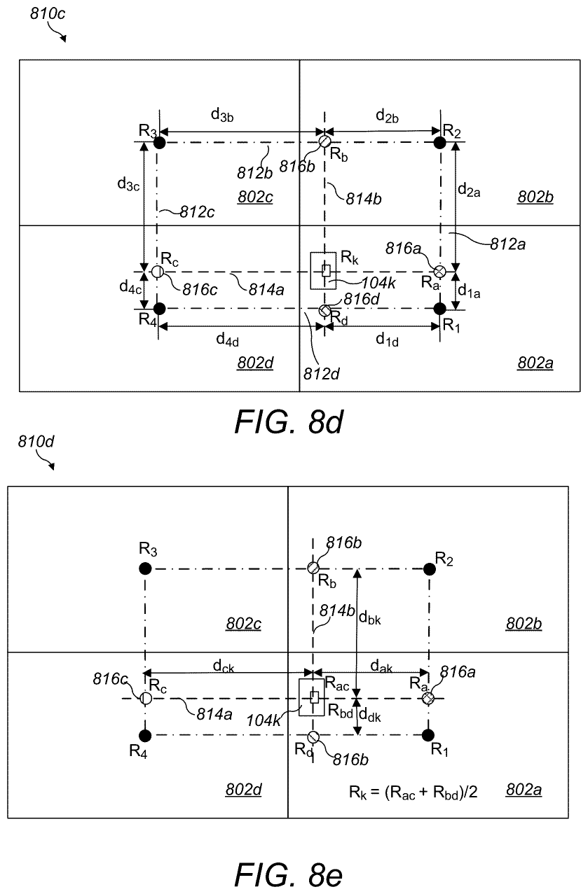

FIG. 8a is a schematic diagram illustrating an example rainfall grid 800 for calculating, for example, a hyper-local rainfall data estimates Rᵢ, Rⱼ or Rₖ at wastewater assets 104i, 104j or 104k when given rainfall data R₁ in the rainfall area 802a the wastewater asset 104, 104j or 104k is located within and rainfall data R₂-R₉ in the rainfall grid areas 802b-802i that are adjacent to rainfall grid area 802a. In this example, the center of each grid area 802a-802i is illustrated as being associated with the corresponding rainfall data R₁ to R₉. Although rainfall data R₁ in rainfall grid area 802a may be used as the rainfall data Ri-Rₖ for wastewater assets 104i-104k located in rainfall grid area 802a, given that rainfall in adjacent rainfall grid areas 802b-802i may contribute to the rainfall data Rᵢ-Rₖ for each of wastewater assets 104i-104k depending on closeness of these assets 104i-104k to each of the adjacent grid areas 802b-802i, it may be more accurate to estimate hyper-local rainfall estimates Rᵢ-Rₖ that relates to the wastewater asset's 104i-104k location within rainfall grid area 802a based on at least three or more rainfall data R₂-R₉ of adjacent grid areas 802b-802i. This may improve the accuracy of the trained ML model 120i in predicting maximum and minimum wastewater thresholds and for the detection of blockages and other rainfall related anomalies at each of wastewater assets 104i-104k. That said, should rainfall data R₂-R₉ for rainfall grid areas 802b-802i not be available then the rainfall data R₁ in the rainfall grid area 802a that the wastewater assets 104i-104k are located may be used.

For example, the hyper-local rainfall data Rᵢ at wastewater asset 104i may be determined based on the rainfall datasets R₁-R₉, which may be received from an external operator such as a weather service provider/weather office/organisation of a country that the wastewater asset 104i is located. The weather service provider may have a weather service that uses measuring apparatus (e.g. rainfall meters or satellite or radar systems) configured for estimating the rainfall on a per X km² basis over regular/periodic time intervals of M time units (e.g. M=15 minutes) each. For example, the weather office (MET office) may make rainfall predictions over a predetermined grid covering a country, state, county or geographic area divided into grid square areas of a certain area such as, without limitation, for example a 1 km area, 1.5 km area, 2 km area or any X km area, X>0. Each of the sensors 108a-108m or wastewater assets 104a-104m may be located within one or more of the grid square areas. The following may be applied to any of the wastewater assets 108a-108m of wastewater network 102 to estimate/calculate a hyper-local rainfall dataset for each of the wastewater wastes 108a-108m.

In FIG. 8a, the wastewater sensor 108i for wastewater asset 104i is located within rainfall grid area 802a. A hyper-local rainfall estimate Rᵢ at wastewater asset 104i may be calculated when given rainfall data R₁ in the rainfall grid area 802a that the wastewater asset 104i is located within, and rainfall data R₂-R₉ in the rainfall grid areas 802b-802i that are adjacent to rainfall grid area 802a. For example, the calculation calculates a weighted combination of at least three of the rainfall data R₁-R₉ based on how close the wastewater asset 104i is to each of the adjacent corresponding rainfall grid areas 802b-802i and where the wastewater asset 104i is located within the rainfall grid area 802a. For example, the calculation of the hyper-local rainfall data Rᵢ at wastewater asset 104i may be based on performing a multivariate interpolation (e.g. two or three dimensional, tri-cubic or tri-linear interpolation, or nearest neighbour interpolation) or any other interpolation/averaging method or process to determine the hyper-local rainfall dataset Rᵢ at the location of the wastewater asset 104i based on the rainfall dataset R₁ covering the rainfall grid area 802a the wastewater asset 104i is located in and at least three other rainfall datasets R₂-R₉ associated with adjacent rainfall grid areas 802b-802i to the rainfall grid area 802a the wastewater asset 104i is located within. For example, for the wastewater asset 104i that is located within the rainfall grid area 802a, it may be determined how close the wastewater asset 104i is located to the borders of each of the adjacent and/or diagonally adjacent rainfall grid areas 802b-802i, and based on these distances, or proportions thereof, calculating a weighting of the rainfall data R₂-R₉ for use in estimating the hyper-local rainfall data Rᵢ at the wastewater asset 104i location.

The hyper-local rainfall data Rᵢ that is calculated for wastewater asset 104i may be used in place of the historical rainfall data R₁ when training the ML model 120i and/or as an estimate of the current rainfall at a particular time instance when input to a trained ML model 120i for predicting minimum and maximum wastewater thresholds, which are used in detecting blockages and/or other anomalies at wastewater asset 104i. The hyper-local rainfall data Rⱼ and Rₖ may also be calculated in a similar manner for wastewater assets 104j and 104k, and/or any of wastewater assets 104a-104m with sensors 108a-108k and applied when training corresponding ML models 120j and 102k or 120a-120m for predicting corresponding minimum and maximum wastewater thresholds.

Although the rainfall data R₂-R₉ of all grid areas 802b-802i adjacent to grid area 802a may be used, along with rainfall data R₁ of grid area 802a, in calculating the hyperlocal rainfall data Rᵢ, Rⱼ and/or Rₖ for wastewater assets 104i, 104j and/or 104k, if may be unnecessary to use all rainfall data R₂-R₉ of grid areas 802b-802i, rather a selection of the grid areas 802b-802i adjacent to grid area 802a that are closest to each of the wastewater assets 104a-104k may be applied to estimate/calculate the corresponding hyperlocal rainfall Rᵢ, Rⱼ and/or Rₖ for each of wastewater assets 104i, 104j, and/or 104k. For example, as illustrated in FIG. 8a, the center of each grid area 802a-802i may be assumed to have rainfall data R₁ to R₉, and each grid areas 802a-802ᵢ may be divided into four equal quadrants. In this example, FIG. 8a illustrates the grid area 802a being divided into grid quadrants 802a-1 to 802a-4. Each of the wastewater assets 104ᵢ-104k located within grid area 802a may be identified to be located within one of the grid quadrants 802a-1 to 802a-4. In this example, wastewater asset 104i is located within grid quadrant 802a-2, wastewater asset 104j is located within grid quadrant 802-3, and wastewater asset 104k is located within grid quadrant 802a-1. Once a grid quadrant of a grid area that a wastewater asset is located within is identified, then the rainfall data of those grid areas adjacent to the grid quadrant of the grid area the wastewater asset is located within are selected for use, along with the rainfall data of the grid area the wastewater asset is located within, in the calculation/estimate of the hyperlocal rainfall data associated with that wastewater asset.

For example, for wastewater asset 104k located within grid area 802a, it can be identified that wastewater asset 104k is located within grid quadrant 802a-1 of the grid area 802a. Given this, then the rainfall data R₂, R₃ and R₄ of those grid areas 802b, 802c and 802d adjacent to grid quadrant 802a-1 are selected for use, along with rainfall data R₁ of grid area 802a, in estimating/calculating the hyperlocal rainfall data estimate Rₖ of wastewater asset 104k within grid area 802a. Similarly, for wastewater asset 104i, which is located within grid quadrant 802a-2, then the rainfall data R₂, R₉ and R₈ of those grid areas 802b, 802i and 802h adjacent to grid quadrant 802a-2 are selected for use, along with rainfall data R₁ of grid area 802a, in estimating/calculating the hyperlocal rainfall data estimate Rᵢ of wastewater asset 104i within grid area 802a. As well, for wastewater asset 104j, which is located within grid quadrant 802a-3, then the rainfall data R₆, R₇ and R₈ of those grid areas 802f, 802i and 802h adjacent to grid quadrant 802a-2 are selected for use, along with rainfall data R₁ of grid area 802a, in estimating/calculating the hyperlocal rainfall data estimate Rᵢ of wastewater asset 104i within grid area 802a. The reduction in the amount of rainfall data from adjacent grid areas that are selected reduces the computational requirements of the interpolation and/or averaging process used when calculating/estimating each hyperlocal rainfall dataset for each of the wastewater assets 104a-104m of wastewater network 102.

FIGS. 8b to 8e illustrate an example hyper-rainfall calculation 810a-810e using interpolation and averaging for estimating/calculating the hyperlocal rainfall Rₖ dataset for wastewater asset 104k located within grid area 802a and grid quadrant 802a-1. This may be applied for each of the wastewater assets 104a-104m of wastewater network 102. As described, the grid areas 802b-802d adjacent to grid quadrant 802-1a that wastewater asset 104k is located within are selected for use in calculating the hyper-local rainfall estimate Rₖ of wastewater asset 104k. In this example, the center of each grid area 802a-802d is labelled with the corresponding rainfall data R₁ to R₄ that is to be used for estimating/calculating the hyper-local rainfall dataset Rₖ of wastewater asset 104k. Referring to FIG. 8b, a first part of the hyper-rainfall calculation 810a is illustrated in which the center of each grid area 802a-802d (e.g. solid dots labelled R₁-R₄) are joined with four line segments 812a-812d (e.g. illustrated as dash-dot lines in FIG. 8b) to form a rectangle (or square) within which wastewater asset 104k is located. For example, a first line segment 812a is formed between center R₁ of grid area 802a and center R₂ of grid area 802b, a second line segment 812b is formed between center R₂ of grid area 802b and center R₃ of grid area 802c, a third line segment 812c is formed between center R₃ of grid area 802c and center R₄ of grid area 802d, and a fourth line segment 812d is formed between center R₄ of grid area 802d and center R₁ of grid area 802a. The first, second, third and fourth line segments 812a-812d (e.g., the dashed-dot lines in FIG. 8a) form a rectangle (or square) within which wastewater asset 104k is located.

Referring to FIG. 8c, a second part of hyperlocal rainfall calculation 810b is illustrated in which the location of the wastewater asset 104k within the rectangle is projected onto each of the first, second, third and fourth line segments 112a-112d in which the locations 816a-816d of the projected location of wastewater asset 104k on each of the line segments 112a-112d is used to calculate first, second, third and fourth rainfall estimates Rₐ, R_{b}, R_{c}, and R_{d}. For example, a first projected line 814a orthogonal to line segments 112a and 112c is projected from the center of wastewater asset 104k until the first projected line 814a intersects at a first and third intersection locations 816a and 816c on the first and third line segments 112a and 112c, respectively. The intersection of the first projected line 814a and first line segment 112a is used as the first intersection location 816a in which to calculate the first rainfall estimate Rₐ, and the intersection of the first projected line 814a with the third line segment 112c is used as a third intersection location 816c in which to calculate a third rainfall estimate R_{c}. Similarly, a second projected line 814b orthogonal to second the fourth line segments 112b and 112d is projected from the center of wastewater asset 104k until the second projected line 814b intersects at second and fourth intersection locations 816b and 816d on the second and fourth line segments 112b and 112d, respectively. The intersection of the second projected line 814b and second line segment 112b is used as the second intersection location 816b in which to calculate the second rainfall estimate R_{b}, and the intersection of the second projected line 814b with fourth line segment 112d is used as the fourth intersection location 816d in which to calculate the fourth rainfall estimate Rd.

Referring to FIG. 8d, a third part of hyperlocal rainfall calculation 810c for wastewater asset 104k is illustrated in which the distances from the pairs of grid centers forming each line segment to the intersection location on said each line segment are determined, where these distances are used to interpolate and estimate the rainfall at the intersection location using the rainfall data associated with the corresponding grid centers. For example, linear interpolation may be applied to determine a weighted average based in the distances and the rainfall data associated with each of the centers of the grid areas may be used to estimate the rainfall data at the intersection location. The weighting of the rainfall data associated with each of the centers of the grid areas are inversely related to the distance from the centers of the grid areas (e.g. end points of the line segment) to the unknown rainfall data at the intersection location on said line segment, where the rainfall data associated with the center of the grid area that is closer to the intersection location has more influence than the other center of the grid area that is farther away from the intersection location.

In the example illustrated in FIG. 8d, the distance from each of the pair of grid centers R₁ and R₂ forming the first line segment 812a to the first intersection location 816a is determined, with the distance from grid center R₁ to the first intersection location 816a being determined as distance d₁ₐ (e.g. in km or m), and the distance from grid center R₂ to the first intersection location 816a being determined as distance d₂ₐ (e.g. in km or m). Using linear interpolation based on the rainfall data R₁ and R₂ and the distances d₁ₐ and d₂ₐ from each grid center of the first line segment 812a to the intersection location 816a, an estimate for rainfall data Rₐ may be calculated based on: Rₐ=(R₁×d₂ₐ+R₂×d₁ₐ)/(d₁ₐ+d₂ₐ).

Similarly, the distance from each of the pair of grid centers R₂ and R₃ forming the second line segment 812b to the second intersection location 816b is determined, with the distance from grid center R₂ to the second intersection location 816b being determined as distance d_{2b} (e.g. in km or m), and the distance from grid center R₃ to the second intersection location 816b being determined as distance d_{3b} (e.g. in km or m). Using linear interpolation based on the rainfall data R₂ and R₃ and the distances d_{2b} and d_{3b} from each grid center of the second line segment 812b to the intersection location 816b, an estimate for rainfall data R_{b} may be calculated based on: R_{b}=(R₂×d_{3b}+R₃×d_{2b})/(d_{2b}+d_{3b}).

Similarly, the distance from each of the pair of grid centers R₃ and R₂ forming the third line segment 812c to the third intersection location 816c is determined, with the distance from grid center R₃ to the third intersection location 816c being determined as distance d_{3c} (e.g. in km or m), and the distance from grid center R₄ to the third intersection location 816c being determined as distance d_{4c} (e.g. in km or m). Using linear interpolation based on the rainfall data R₃ and R₄ and the distances d_{3c} and d_{4c} from each grid center of the third line segment 812c to the intersection location 816c, an estimate for rainfall data R_{c} may be calculated based on: R_{c}=(R₃×d_{4c}+R₄×d_{3c})/(d_{3c}+d_{4c}).

Similarly, the distance from each of the pair of grid centers R₄ and R₁ forming the fourth line segment 812d to the fourth intersection location 816d is determined, with the distance from grid center R₄ to the fourth intersection location 816d being determined as distance d_{4d} (e.g. in km or m), and the distance from grid center R₁ to the fourth intersection location 816d being determined as distance did (e.g. in km or m). Using linear interpolation based on the rainfall data R₄ and R₁ and the distances d_{4d} and d_{1d} from each grid center of the fourth line segment 812d to the intersection location 816d, an estimate for rainfall data Rₐ may be calculated based on: R_{d}=(R₁×d_{4d}+R₄×d_{1d})/(d_{1d}+d_{4d}).

Referring to FIG. 8e, a fourth part 810d of hyperlocal rainfall calculation 810d for wastewater asset 104k is illustrated in which the pairs of intersection locations are used to form two line segments 814a and 814b intersecting the wastewater asset 104k. For each of these line segments 814a and 814b distances from the corresponding pairs of intersection locations to the wastewater asset 104k are determined. For each of the line segments 814a and 814b, the distances are used to interpolate and estimate the first and second intermediate rainfall estimates R_{ac} and R_{bd} at the intersection location of wastewater asset 104k using the first and third rainfall data estimates Rₐ and R_{c} and the second and fourth rainfall data estimates R_{b} and R_{d}, respectively, that were calculated for the corresponding intersection locations. The resulting intermediate rainfall data estimates R_{ac} and R_{bd} associated with the two line segments 814a and 814b may then be averaged to form the hyperlocal rainfall dataset Rₖ for wastewater asset 104k.

In the example illustrated in FIG. 8e, the distance from each of the pair of intersection locations 816a and 816c forming the first intersection line segment 814a is determined, with the distance from the first intersection location 816a to the wastewater asset 104k on the first intersection line segment 814a being determined as distance dₐₖ (e.g. in km or m), and the distance from the third intersection location 816c to the wastewater asset 104k on the first intersection line segment 814a being determined as distance d_{ck} (e.g. in km or m). Using linear interpolation based on the first and third rainfall data estimates Rₐ and R_{c} calculated in the third part of the hyperlocal rainfall calculation 810c for wastewater asset 104k and the distances dₐₖ and d_{ck}, an estimate for first intermediate rainfall data estimates R_{ac} may be calculated based on: R_{ac}=(Rₐ×d_{dk}+R_{c}×dₐₖ)/(dₐₖ+d_{ck}).

Similarly, the distance from each of the pair of intersection locations 816b and 816d forming the second intersection line segment 814b is determined, with the distance from the second intersection location 816b to the wastewater asset 104k on the second intersection line segment 814b being determined as distance d_{bk} (e.g. in km or m), and the distance from the fourth intersection location 816d to the wastewater asset 104k on the second intersection line segment 814b being determined as distance dₐₖ (e.g. in km or m). Using linear interpolation based on the second and fourth rainfall data estimates R_{b} and Rₐ calculated in the third part of the hyperlocal rainfall calculation 810c for wastewater asset 104k and the distances d_{bk} and d_{dk}, an estimate for second intermediate rainfall data estimates R_{bd} may be calculated based on: R_{bd}=(R_{b}×d_{dk}+R_{d}×d_{bk})/(d_{bk}+d_{dk}).

Once the first and second intermediate rainfall data estimates R_{ac} and R_{bd} have been calculated, the hyperlocal rainfall data estimate Rₖ for wastewater asset 104k may be calculated based on: Rₖ=(R_{ac}+R_{bc})/2. The hyperlocal rainfall calculation outlined in FIGS. 8b to 8e may be performed on each corresponding rainfall measurement of rainfall datasets R₁, R₂, R₃, and R₄ to form the hyperlocal rainfall estimate dataset Rₖ for wastewater asset 104k of wastewater network 102.

Although FIGS. 8b to 8e describe a hyperlocal rainfall calculation for hyperlocal rainfall dataset Rₖ for wastewater asset 104k, this is by way of example only and the invention is not so limited, it is to be appreciated by the skilled person that the hyperlocal rainfall calculation outlined in FIGS. 8b to 8e may be applied to each of the wastewater assets 104a-104m of wastewater network 102.

When the wastewater measurements 114 from the sensors 108a-108m of each of the wastewater assets 104a-104m of the wastewater network 102 is received by the ingestion unit 110b, the ingestion unit 110b performs the above methodologies separately for each of the wastewater assets 104a-104m. For each wastewater asset 104i of the wastewater network, there are two sets of data, cleaned synchronised normalised wastewater measurement dataset of the sensor 108i for the wastewater asset 104i and updated environmental data including corresponding hyperlocal rainfall data Rᵢ (or, if unavailable, rainfall data R₁), both of which are time series datasets that are synchronised in a time series at the hyperlocal rainfall data Rᵢ (or rainfall data R₁) time interval of M time units (e.g. 15 minutes) between adjacent data value time instances.

It is noted that the cleaned synchronised normalised wastewater measurement dataset of the sensor 108i for the wastewater asset 104i is a time series dataset that includes at least three data values per time instance in the time series, namely, a mean value, maximum value and minimum value representative of the wastewater level or flow. In this example, these data values are represented as a capacity percentage, a skilled person would understand that any other normalisation may be applied as the application demands.

Although the following describes the operations and/or processes for training ML model 120i for wastewater asset 104i, this is by way of example only and the invention is not so limited, the skilled person would appreciate that these operations and/or processes may be used for training each of the ML models 102a-102m of each of the wastewater assets 104a-104m of wastewater network 102, and/or used for updating each of the ML models 120a-120m of the wastewater assets 104a-104m of wastewater network 102. Operations 208 and/or process 300 of FIGS. 2 and 3 may be used to train an ML model 120i for wastewater asset 104i to predict data representative of the maximum and minimum wastewater levels given the current rainfall data instance at time ti. The ML algorithm that is used to train the model parameters of the ML model 120i may include one or more ML algorithms from the group of: regression algorithms or boosting algorithms (e.g. XGBoost, Adaboost, gradient boost regressor and the like), bagging algorithms, neural networks, and/or any other ML algorithm capable of tracking the behaviour of the mean, minimum and/or maximum wastewater levels or flow through wastewater asset 104i given current rainfall data and/or any other type of environmental data such as, without limitation, river level data, ground water level data, flood water level data, tidal level data and the like.

Although in this example rainfall data associated with the wastewater asset 104i (or hyper local rainfall data of wastewater asset 104i or rainfall data in the rainfall grid area the wastewater asset 104i is located within) is used, for simplicity and by way of example only and the invention is not so limited, it is to be appreciated by the skilled person that in addition to rainfall data (or hyper local rainfall data of wastewater asset 104i or rainfall data in the rainfall grid area the wastewater asset 104i is located within), other types of environmental time series datasets may be used such as river level time series data, ground water level time series data, flood water level time series data and tidal level time series data in which each time series dataset is synchronised to the time series rainfall dataset.

The training dataset for training ML model 120i includes two sets of data, the cleaned synchronised normalised wastewater measurement dataset of the sensor 108i for the wastewater asset 104i and corresponding hyperlocal rainfall data Ri calculated for the wastewater asset 104i (or simply rainfall data R₁ of the rainfall grid area that the wastewater asset 104i is located in). The cleaned synchronised normalised wastewater measurement dataset of the sensor 108i for the wastewater asset 104i is a time series dataset that includes three data values per time instance in the time series, namely, a mean value, maximum value and minimum value representative of the wastewater level or flow. In this example, these data values are represented as a capacity percentage, but a skilled person would understand that any other normalisation may be applied as the application demands.

In this example, the ML algorithm that was found to be very successful in tracking the behaviour of wastewater levels or flow through wastewater asset 104i for blockage detection may be chosen from the regression or boosting type family of ML algorithms including, but not limited to, XGBoost, Adaboost, gradient boost regressor ML algorithms. However, any other type of ML algorithm may be used that is capable or suitable for tracking the behaviour of wastewater levels or flow through wastewater asset 104i for blockage detection using time series datasets such as cleaned synchronised normalised wastewater measurement dataset of the sensor 108i for the wastewater asset 104i and corresponding hyperlocal rainfall data Rᵢ calculated for the wastewater asset 104i (or simply rainfall data R₁ of the rainfall grid area that the wastewater asset 104i is located in).

Prior to training the model parameters for the ML model 120i using the chosen ML algorithm (e.g. XGBoost, Adaboost, gradient boost regressor), a set of hyperparameter grid ranges is required to be selected for use in performing the hyperparamter grid search for finding the optimal hyperparameters for use in training the ML model 120i. Hyperparameters are settings or model parameters whose values are set before training that affect how an ML model is trained. Various hyperparameters for the above chosen ML algorithm may include, without limitation, for example, rainfall durations or time windows, learning rates, base estimator, number of estimators, and the like.

An example of hyperparameter ranges for the number of estimators include, without limitation, for example [100, 200, 400, 600] or any other suitable number of estimators value. An example of hyperparameter ranges for learning rates include, without limitation, for example [0.1, 0.3, 0.6, 0.8] and/or any other suitable learning rate value etc. The rainfall input durations (or rainfall time windows) represent the amount of previous rainfall data in the time series from the current rainfall data instance that is taken into account and input as current rainfall data during training and/or inferencing. For example, the rainfall duration may affect the wastewater level or flow for 1 day, 2 days, 3 days, 5 days, 10 days or any number of R days. For example, hyperparameter ranges for rainfall duration values (in days) may include, without limitation, for example [0, 1, 2, 3, 5, 10], where this means that for each 15 minute rainfall data instance that is input for training and/or inference then either: only the 15 minute rainfall data instance is used as the current rainfall data input for training and/or inference; the previous 1 days of rainfall from the 15 minute rainfall data instance is used as the current rainfall data input for training and/or inference; the previous 2 days of rainfall from the 15 minute rainfall data instance is used as the current rainfall data input for training and/or inference; the previous 3 days of rainfall from the 15 minute rainfall data instance is used as the current rainfall data input for training and/or inference; the previous 5 days of rainfall from the 15 minute rainfall data instance is used as the current rainfall data input for training and/or inference; the previous 10 days of rainfall from the 15 minute rainfall data instance is used as the current rainfall data input for training and/or inference, and so on. The rainfall duration or time window is used to determine how rainfall affects the wastewater level or flow at wastewater asset 104i. Thus, when performing the hyperparameter grid search the best performing ML model will have the optimal settings for rainfall duration, which will also be applied when inputting the current rainfall data to the ML model 120i.

As described with reference to operation 208 and process 300 of FIGS. 2 and 3, a hyperparameter grid search is performed using a chosen ML algorithm (e.g. e.g. XGBoost, Adaboost, gradient boost regressor, or other suitable ML algorithm) to train model parameters for generating a plurality of sets of ML models (each set of ML models including a mean ML model, minimum ML model and maximum ML model) using all combinations of the selected hyperparameters (e.g. rainfall input duration, learning rate, base estimator, number of estimators and other hyperparameters) and a training dataset comprising the cleaned synchronised normalised wastewater measurement dataset of the sensor 108i for the wastewater asset 104i and the corresponding hyperlocal rainfall data Rᵢ calculated for the wastewater asset 104i (or simply rainfall data R₁ of the rainfall grid area that the wastewater asset 104i is located in). Each set of ML models includes a mean ML model, minimum ML model and a maximum ML model each of which having been trained using the mean, minimum and maximum time series data sets of the cleaned synchronised normalised wastewater measurement dataset, respectively, and the corresponding hyperlocal rainfall data Ri calculated for the wastewater asset 104i (or simply rainfall data R₁ of the rainfall grid area that the wastewater asset 104i is located in).

All of the generated ML models of the plurality of sets of ML models are ranked and scored against the validation data based on model performance statistics such as, without limitation, for example RMSE and/or MSE or other model performance metric. For example, there may be a training/validation data split of the cleaned synchronised normalised wastewater measurement dataset and the corresponding hyperlocal rainfall data Rᵢ (or simply rainfall data R₁) for training and validation for scoring (e.g., train on one part, score on another part, or if small dataset train on all and score on all etc.) or by any ML training/validation techniques as is well known by the skilled person. In this example, the RMSE and MSE is used to score the plurality of sets of ML models. The best performing ML model having the best RMSE and MSE from the ranked plurality of sets of ML models (e.g., it could be one of a mean ML model, maximum ML model or even minimum ML model) is selected. The set of ML models that the selected ML model belongs to is identified and the minimum and maximum ML models from that set (e.g., this could be the selected ML model) are used to build the final ML model 120i, which comprises the minimum ML model for use in predicting data representative of the minimum wastewater thresholds and the maximum ML model for predicting data representative of the maximum wastewater thresholds given current rainfall data. The final ML model 120i for wastewater asset 104i may be formed as described with reference to FIG. 1d or 1e. Thus, the hyperparameters used for training the selected ML model have been used to train the minimum and maximum ML models, and so the rainfall duration hyperparameter from these hyperparameters is used to form the input to the final ML model 120i. That is, the current rainfall data that is input to the final ML model 120i includes the current rainfall data instance at time ti (e.g., M=15 minutes) and also the previous rainfall data instances within the rainfall duration period (or rainfall time window).

Alternatively, to reduce the number of computational resources required to perform the hyperparameter grid search, the hyperparameter grid search may be performed to find the best mean ML model. For example, a hyperparameter grid search is performed using a chosen ML algorithm (e.g., XGBoost, Adaboost, gradient boost regressor, or other suitable ML algorithm) to train model parameters for generating a plurality of mean ML models for predicting mean value thresholds using all combinations of the selected hyperparameters (e.g. rainfall input duration, learning rate, base estimator, number of estimators and other hyperparameters) and a training dataset comprising only the mean values of the cleaned synchronised normalised wastewater measurement dataset of the sensor 108i for the wastewater asset 104 and the corresponding hyperlocal rainfall data Rᵢ calculated for the wastewater asset 104i (or simply rainfall data R₁ of the rainfall grid area that the wastewater asset 104i is located in). All of the generated ML models of the plurality of mean ML models are ranked and scored against the validation data based on model performance statistics such as, without limitation, for example RMSE and/or MSE or other model performance metric. For example, there may be a training/validation data split of the mean values of the cleaned synchronised normalised wastewater measurement dataset and the corresponding hyperlocal rainfall data Rᵢ (or simply rainfall data R₁) for training and validation for scoring (e.g., train on one part, score on another part, or if small dataset train on all and score on all etc.) or by any ML training/validation techniques as is well known by the skilled person. In this example, the RMSE and MSE is used to score the plurality of mean ML models. The best performing mean ML model having the best RMSE and MSE from the ranked plurality mean ML models is selected.

The hyperparameters used for training the selected mean ML model are then used to train a minimum ML model for predicting data representative of minimum wastewater thresholds using the minimum values of the cleaned synchronised normalised wastewater measurement dataset of the sensor 108i for the wastewater asset 104i and the corresponding hyperlocal rainfall data Rᵢ calculated for the wastewater asset 104i (or simply rainfall data R₁ of the rainfall grid area that the wastewater asset 104i is located in). As well, the hyperparameters used for training the selected mean ML model are used to train a maximum ML model for predicting data representative of maximum wastewater thresholds using the maximum values of the cleaned synchronised normalised wastewater measurement dataset of the sensor 108i for the wastewater asset 104i and the corresponding hyperlocal rainfall data Rᵢ calculated for the wastewater asset 104i (or simply rainfall data R₁ of the rainfall grid area that the wastewater asset 104i is located in). The final ML model 120i is built based on the minimum ML model for use in predicting data representative of the minimum wastewater thresholds and the maximum ML model for predicting data representative of the maximum wastewater thresholds given current rainfall data. The final ML model 120i for wastewater asset 104i may be formed as described with reference to FIG. 1d or 1e. The hyperparameters used for training the selected mean ML model have been used to train the minimum and maximum ML models, and so the rainfall duration hyperparameter from these hyperparameters is used to form the input to the final ML model 120i. That is, the current rainfall data that is input to the final ML model 120i includes the current rainfall data instance at time ti (e.g., M=15 minutes) and also the previous rainfall data instances within the rainfall duration period (or rainfall time window). The RMSE and MSE scores for the minimum and maximum ML models may be used to adjust the predicting minimum and maximum wastewater thresholds by a percentage amount depending on the RMSE/MSE score.

As well, the output predicted minimum and maximum wastewater thresholds may also be filtered/smoothened and may be further widened based on the RMSE/MSE score to become the predicted minimum and maximum wastewater thresholds, respectively, when output from the final ML model 120i.

Minimum and maximum wastewater threshold widening may depend on how accurate RMSE or MSE scores are. For example, a threshold adjustment table may be formed that maps a range of RMSE scores to a specific threshold adjustment (e.g., a percentage threshold adjustment). Thus, when the RMSE score of a minimum or maximum ML model falls within the RMSE ranges of the threshold adjustment table then the corresponding percentage threshold amount may be used to widen the corresponding minimum or maximum predicted wastewater threshold that is output.

The threshold adjustment table may be derived empirically from backtesting and observing the behaviour of the ML models 120a-102m of one or more wastewater assets 104a-104m of wastewater network 102 and fine tuning the output for reducing false positives/negatives in relation to historical wastewater data and previously identified blockages and other anomalies the like.

Thus, the final ML model 120i for wastewater asset 104i takes as input current rainfall data, which includes all previous rainfall data instances covered by the rainfall duration period, and outputs data representative of predicted minimum and maximum wastewater thresholds. The above processes and procedures may be performed at each of the wastewater assets 104a-104m to build an ML model for predicting minimum and maximum wastewater thresholds for each of those wastewater assets 104a-104m of wastewater network 102.

Anomaly detection may now be performed at each of the wastewater assets 104a-104m using the ML models 120a-120m based on the anomaly detection unit 110c and/or anomaly detection operations described with reference to FIGS. 1a-1e and anomaly detection process 400 of FIG. 4. For example, as sensor wastewater measurements 114i for wastewater asset 104i are received over time at time intervals of duration N time units (e.g., every 1, 2, 3, 5 minutes or any suitable N minute intervals), this data may be normalised (but not synchronised to the rainfall measurement time interval M (e.g., M=15 minutes)) to be represented as a capacity percentage (or other suitable normalisation) as previously described. At each rainfall measurement time instance (e.g., received every M minute intervals), a current rainfall data instance (e.g. at an i-th time instance) may be received and processed and/or any other environmental measurement data at the i-th time instance. Preferably the time interval duration N<the time interval duration M. The received current rainfall data instance at the i-th time instance along with previous or historical rainfall data instances within the rainfall duration period (determined during hyperparameter grid search/training) going back in time from the i-th time instance is applied to the ML model 120i, which is processes this input data, and outputs data predicting minimum and maximum wastewater thresholds for the wastewater asset 104i for the (i+1)-th time instance.

Determining whether an anomaly occurs at wastewater asset 104i based on pattern of a collected time series of normalised received sensor wastewater measurements 114i collected at time intervals N with respect to a collected time series of the previous predicted minimum and maximum wastewater thresholds and the current predicted minimum and maximum wastewater thresholds for the (i+1)-th time instance of the wastewater asset 104i.

For example, as described with respect to FIGS. 1a-1e, a blockage anomaly may be detected when the normalised sensor measurement data from wastewater asset 104i (e.g., the actual wastewater level or flow) goes outside the predicted minimum and maximum wastewater thresholds for a continuous period of time (or an anomaly duration). This is a downstream blockage pattern when the normalised sensor measurement data from wastewater asset 104i (e.g., the actual wastewater level or flow) goes above the predicted maximum wastewater thresholds for a continuous period of time (or an anomaly duration). This is an upstream blockage pattern when the normalised sensor measurement data from wastewater asset 104i (e.g., the actual wastewater level or flow) goes below the predicted minimum wastewater thresholds for a continuous period of time (or an anomaly duration).

A sensor misalignment anomaly or sensor debris anomaly may be detected when the normalised sensor measurement data from wastewater asset 104i (e.g., the actual wastewater level or flow) oscillates inside and outside the predicted minimum and/or maximum wastewater thresholds over another continuous period of time (or another anomaly duration). For example, the sensor beam is hitting iron steps (for access) within the wastewater asset 104i and so may oscillate above and below the predicted thresholds. For example, a piece of debris or cabling is periodically interrupting the sensor beam so the sensor reading may oscillate above/below the predicted thresholds.

Another sensor communication anomaly, sensor calibration/error anomaly or even sensor misalignment anomaly may be detected when the normalised sensor measurement data from wastewater asset 104i (e.g., the actual wastewater level or flow) is a constant reading inside and/or outside of the predicted minimum and/or maximum wastewater thresholds over a further continuous period of time (or a further anomaly duration)). For example, the sensor is focused on a wall or hitting an obstacle so provides a constant reading when the wastewater level is below that location within the wastewater asset 104i. For example, the sensor may have a communications error, where only null values are reported or no values are reported.

The anomaly patterns and various anomaly durations/continuous periods of time may be determined by backtesting the ML model 120i and observing the thresholds on previous blockages and/or anomalies, and determining reasonable anomaly durations over which an anomaly may be reliably determined, detected and indicated for alerting, and may depend on the RMSE of the ML model 120i and/or how accurate the predicted, then an anomaly is predicted, how long it goes outside thresholds (e.g. anomaly duration), depends on RME and how accurate the predicted minimum and maximum wastewater thresholds are. This is because each wastewater asset 104i (e.g., each site) is variable in consistency and may have different behaviours regarding blockages and/or anomalies and the like. The anomaly duration may also be set as a function of the rainfall and other environmental factors. There may be multiple different anomaly durations that may be set and stored in a table for each wastewater asset for use by anomaly detection unit 110c in detecting and identifying anomalies and the like.

In essence, these anomaly patterns may be used to determine whether sensor error or blockage based on the pattern of collected normalised wastewater measurements and collected maximum and minimum predictions over one or more continuous periods of time (or anomaly duration periods), which may be different for each type of anomaly pattern. Once an anomaly pattern is detected, e.g., checking whether an anomaly has occurred based on the above determinations and anomaly patterns. If an anomaly has occurred, then sending an indication or alert of the detected anomaly at wastewater asset 104i to wastewater management system 100 for arranging maintenance and/or repair of wastewater asset 104i. Otherwise, the anomaly detection process continues to receive sensor measurement data from wastewater asset 104i over time until the (i+1)-th time instance and continues to perform anomaly pattern detection as described.

Although the ML models 102a-102m for each of the wastewater assets 104a-104m have been described as being trained primarily on rainfall data, this is by way of example only and the invention is not so limited, it is to be appreciated that other types of environmental datasets may be used such as, for example, river levels, ground water levels, tidal patterns and/or levels, and the like. This is because, in certain cases and depending on the location of each of the wastewater assets 104a-104m, river water, sea water and/or ground water may seep into the wastewater network 102 based on river levels, tidal levels/patterns, and ground water levels respectively. If this is the case, then sometimes the minimum and maximum predictions will improve when, in addition to rainfall data, adding one or more of these types of environmental data as input during training and inference. If any of these other types of environmental data improves the resulting ML model then include these as input to those ML models going forward.

Thus, the hyperparameter grid search as described herein may be further modified by including further hyperparameters as an environment hyperparameter range for selecting one or more types of environmental data to be used during training, where the environment hyperparameter range may be, for example, [rainfall, river, ground, tidal]. This may be used during the hyperparameter grid search to include all the different combinations of environmental training data that may be used. Thus, the hyperparameters of the best ML model that is selected from the ranked and scored plurality of ML models will now also indicate whether river level, ground water level, tidal patterns/levels and the like also have an influence on the wastewater asset 104i and may provide improved predicted minimum and maximum wastewater thresholds for anomaly detection. An advantage of including further types of environmental data is that the maximum and minimum thresholds may be predicted more accurately even if one or more of the wastewater assets 104a-104i or wastewater network 102 is affected by river water ingress, ground water ingress, tidal water ingress.

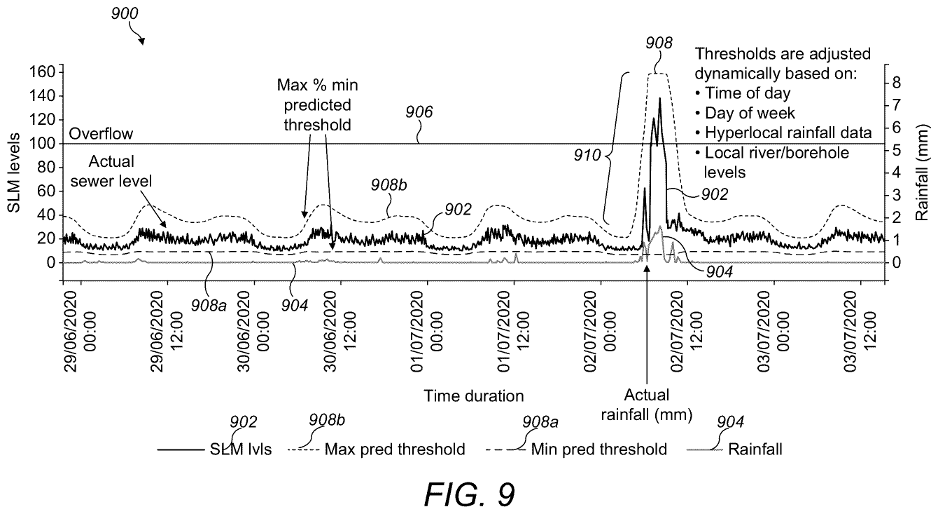

FIG. 9 illustrates an example plot 900 representing normal wastewater flow or level 902 for an example wastewater asset of a wastewater network according to some embodiments of the invention. On this plot 900, the x-axis represents time duration over a time period of 2 months from 00:00 29 Jun. 2020 to 12:00 3 Jul. 2020, and the left y-axis represents normalised wastewater level or flow measurements 902 (e.g., Sewer Level Measurements (SLM)), normalised as a capacity percentage in relation to the capacity of the example wastewater asset to which the sensor is calibrated. On this plot 900, rainfall measurement data 904 in relation to the example wastewater asset is also plotted, where the right y-axis of plot 900 represents rainfall in millimetres (mm). The normalised wastewater measurements 902 may be normalised as described with reference to operation 202 of FIG. 2 and/or as described herein. The rainfall measurement data 904 may comprise hyper-local rainfall data estimated from rainfall data periodically received from a weather service every M time units (e.g., every 15 minutes) for the example wastewater asset as described with reference to FIGS. 8a-8e and/or as herein described. The plot 900 also illustrates that a capacity of 100% represents an overflow level 906, whereby when the wastewater asset reaches 100% capacity wastewater may be redirected via an overflow mechanism or pipe away from the wastewater asset site to prevent flooding and the like.

In operation, the sensor of the example wastewater asset sends raw sensor readings representing wastewater level measurements measured in the chamber of the example wastewater asset to ML anomaly detection apparatus 110, which the ingestion unit 110b normalises each received sensor reading into a normalised wastewater measurement 902 (e.g., normalised as a capacity percentage). The ingestion unit 110b may also generate, at each time instance of M time units (e.g., 15 minutes), a current rainfall data based on either: a) rainfall data periodically received from the weather service every M time units (e.g. every 15 minutes) for the example wastewater asset; b) a hyper-local rainfall estimate calculated from rainfall data periodically received from the weather service every M time units (e.g. every 15 minutes) for the example wastewater asset as described with reference to FIGS. 8a-8e and/or as herein described; or c) any other current rainfall estimate received in relation to the example wastewater asset. At the current time instance, the current rainfall data is input by the ML unit 110a to a trained ML model (e.g., trained using an ML algorithm (e.g., regressor, XGBoost, AdaBoost, or gradient Boost) as described with reference to FIGS. 1a to 8). The trained ML model is configured to process the current rainfall data as input and, from processing this, predict data representative of minimum and maximum wastewater thresholds 908a and 908b for the next time instance as described herein. Anomaly detection unit 110c processes the minimum and maximum wastewater thresholds 908a and 908b for the next time instance, and also a time series of previously collected minimum and maximum wastewater thresholds 908a and 908b for previous time instances, in relation to the received normalised wastewater measurements (e.g., a time series of collected normalised wastewater measurements) to determine whether an anomaly (e.g., blockage, sensor error and the like) can be detected. The wastewater threshold prediction process of ML unit 110a and/or detection process of 110c are each driven by the data ingestion unit 110b receiving sensor readings and rainfall data in relation to the example wastewater asset.

The plot 900 shows the predicted minimum and maximum wastewater thresholds 908a and 908b, respectively, represented as dashed lines dynamically changing over the 2-month time period as a function of the rainfall 904 affecting the example wastewater asset. It can be seen that in normal conditions, the predicted minimum and maximum wastewater thresholds 908a and 908b track the normalised wastewater measurements 902 based on rainfall 904. The plot 900 represents a normal operating condition of the example wastewater asset when the normalised wastewater measurements 902 remain inside the predicted minimum and maximum wastewater thresholds 908a and 908b. A storm event 910 is illustrated in which a storm caused excess rainfall 904 resulting in an overflow condition 906 of the example wastewater asset. However, even though there was an overflow condition 906, this still represents normal behaviour of the example wastewater asset because the normalised wastewater measurements 902 remain inside the predicted minimum and maximum wastewater thresholds 908a and 908b. The plot 900 shows that the ML model that was trained, as described with reference to FIGS. 1a-8e, for the example wastewater asset is capable of predicting minimum and maximum wastewater thresholds 908a and 908b for normal conditions and behaviour of the example wastewater asset in relation to rainfall affecting the example wastewater asset.

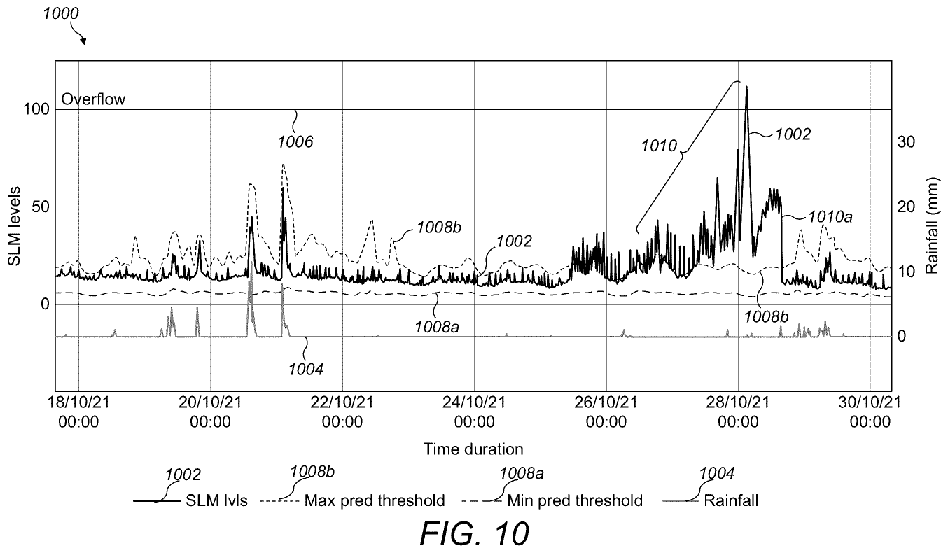

FIG. 10 illustrates an example plot representing a downstream blockage anomaly event being detected for an example wastewater asset of a wastewater network according to some embodiments of the invention. On this plot 1000, the x-axis represents time duration over a time period of 12 days from 00:00 18 Oct. 2021 to 00:00 30 Oct. 2021, and the left y-axis represents normalised wastewater level or flow measurements 1002 (e.g., Sewer Level Measurements (SLM)), normalised as a capacity percentage in relation to the capacity of the example wastewater asset to which the sensor is calibrated. On this plot 1000, rainfall measurement data 1004 in relation to the example wastewater asset is also plotted, where the right y-axis of plot 1000 represents rainfall in millimetres (mm). The normalised wastewater measurements 1002 may be normalised as described with reference to operation 202 of FIG. 2 and/or as described herein. The rainfall measurement data 1004 may comprise hyper-local rainfall data estimated from rainfall data periodically received from a weather service every M time units (e.g., every 15 minutes) for the example wastewater asset as described with reference to FIGS. 8a-8e and/or as herein described. The plot 1000 also illustrates that a capacity of 100% represents an overflow level 1006, whereby when the wastewater asset reaches 100% capacity wastewater may be redirected via an overflow mechanism or pipe away from the wastewater asset site to prevent flooding and the like.

The operation of the ML anomaly detection unit 110 of wastewater system 100 is similar to that as described with reference to FIGS. 1a to 9. The plot 1000 shows the predicted minimum and maximum wastewater thresholds 1008a and 1008b, respectively, represented as dashed lines dynamically changing over the 12-day time period as a function of the rainfall 1004 affecting the example wastewater asset. It is noted that the predicted minimum and maximum wastewater thresholds 1008a and 1008b represent a prediction of minimum and maximum wastewater thresholds 1008a and 1008b when wastewater asset operates under normal conditions. It can be seen that in normal conditions (e.g., a normal flow or level of wastewater flowing through the example wastewater asset), the predicted minimum and maximum wastewater thresholds 1008a and 1008b track based on rainfall 1004 the normalised wastewater measurements 1002. This is when the normalised wastewater measurements 1002 remain inside the predicted minimum and maximum wastewater thresholds 1008a and 1008b.

As shown in plot 1000, the example wastewater asset operates normally until about day 8 (e.g., 26 October 2021) after which the normalised wastewater measurements 1002 begin to rise above the predicted maximum wastewater threshold 1008b. A downstream blockage event 1010 event is illustrated in which, even though rainfall 1004 remained relatively normal, wastewater accumulated within the example wastewater asset and the normalised wastewater measurements 1002 remained above the predicted maximum wastewater threshold 1008b for a continuous period of time associated with an anomaly duration indicating a downstream blockage of the example wastewater asset. The anomaly duration may be manually set and/or empirically determined from backtesting the ML model and ML anomaly detection apparatus 110a in relation to the example wastewater asset to determine suitable continuous durations of time after which the system indicates that a downstream blockage has been detected. The continuous period of time may also change as a function of rainfall and/or other environmental factors affecting example wastewater asset. Once the downstream blockage event 1010 was detected and alerted to the wastewater management system of the wastewater network. A maintenance event 1010a is illustrated, where maintenance of the wastewater asset was performed approximately on the afternoon of 29 Oct. 2021 after which normal wastewater flow resumed. The resumption of the normal wastewater flow is indicated by the normalised wastewater measurements 1002 falling and remaining inside the predicted minimum and maximum wastewater thresholds 1008a and 1008b.

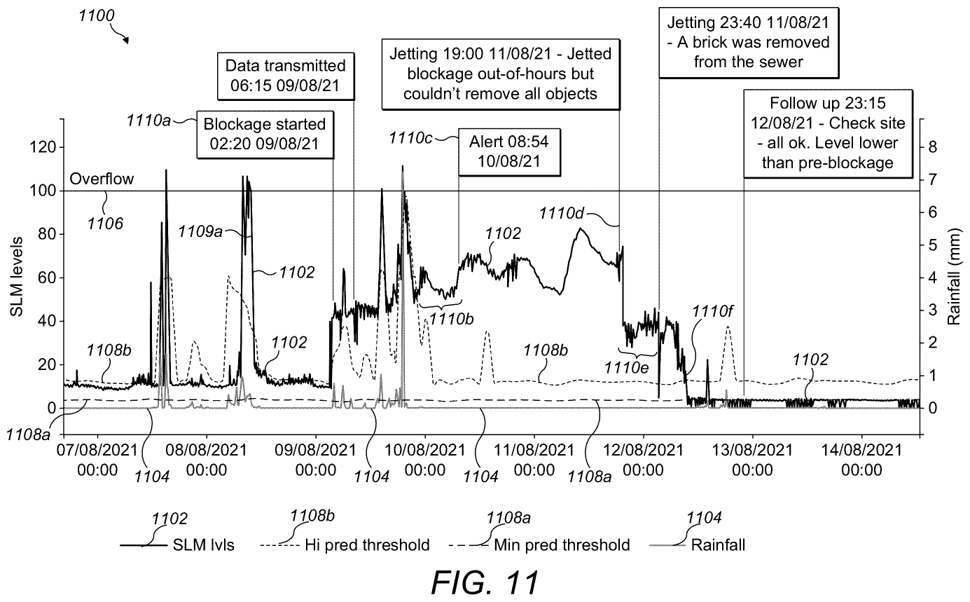

FIG. 11 illustrates another example plot representing a downstream blockage anomaly event being detected for a wastewater asset of a wastewater network according to some embodiments of the invention. On this plot 1100, the x-axis represents time duration over a time period of 7 days from 00:00 7 Aug. 2021 to 00:00 14 Aug. 2021, and the left y-axis represents normalised wastewater level or flow measurements 1102 (e.g., Sewer Level Measurements (SLM)), normalised as a capacity percentage in relation to the capacity of the example wastewater asset to which the sensor is calibrated. On this plot 1100, rainfall measurement data 1104 in relation to the example wastewater asset is also plotted, where the right y-axis of plot 1100 represents rainfall in millimetres (mm). The normalised wastewater measurements 1102 may be normalised as described with reference to operation 202 of FIG. 2 and/or as described herein. The rainfall measurement data 1104 may comprise hyper-local rainfall data estimated from rainfall data periodically received from a weather service every M time units (e.g., every 15 minutes) for the example wastewater asset as described with reference to FIGS. 8a-8e and/or as herein described. The plot 1100 also illustrates that a capacity of 100% represents an overflow level 1106, whereby when the wastewater asset reaches 100% capacity wastewater may be redirected via an overflow mechanism or pipe away from the wastewater asset site to prevent flooding and the like.

The operation of the ML anomaly detection unit 110 of wastewater system 100 is similar to that as described with reference to FIGS. 1a to 10. The plot 1100 shows an example of the resulting predicted minimum and maximum wastewater thresholds 1108a and 1108b, respectively, represented as dashed lines dynamically changing over the 7-day time period as a function of the rainfall 1104 affecting the example wastewater asset. It is noted that the predicted minimum and maximum wastewater thresholds 1108a and 1108b represent a prediction of minimum and maximum wastewater thresholds 1108a and 1108b when wastewater asset operates under normal conditions. It can be seen that in normal conditions (e.g., a normal flow or level of wastewater flowing through the example wastewater asset), the predicted minimum and maximum wastewater thresholds 1108a and 1108b track based on rainfall 1104 the normalised wastewater measurements 1102. This is when the normalised wastewater measurements 1102 remain inside the predicted minimum and maximum wastewater thresholds 1108a and 1108b.

The example wastewater asset operates relatively normally until about day 1.5 (e.g., 8 Aug. 2021 approx. 12:00). As shown in plot 1100, even though there was a possible anomaly event 1109a on day 1.5 (e.g., 8 Aug. 2021 12:00) where the normalised wastewater measurements 1002 rose above the predicted maximum wastewater threshold 1108b and the overflow 1106, this may have been due to excessive rainfall and/or the blockage may have naturally shifted enough to allow wastewater asset to resume normal flow. This possible blockage was not detected as an anomaly because the normalised wastewater measurements 1102 did not remain continuously above the predicted maximum wastewater threshold 1108b for the required anomaly detection duration for this example wastewater asset, and also normal wastewater flow resumed after the rainfall had passed through the wastewater network.

Thus, thereafter the example wastewater asset operated relatively normally until about day 2 (e.g., 9 Aug. 2021 02:20) in which a blockage event 110a started to occur in which the normalised wastewater measurements 1102 begin to rise above the predicted maximum wastewater threshold 1108b. Although the normalised wastewater measurements 1102 rose above and below the predicted maximum wastewater threshold 1108b, they did not rise above the predicted maximum wastewater threshold 1108b for a continuous period of time for the required anomaly detection duration 1110b until the morning of 10 Aug. 2021, after which a downstream blockage event 1110c event is detected. Once the downstream blockage event 1110c was detected, it was alerted (e.g., Alert on 10 Aug. 2021 08:54) to the wastewater management system of the wastewater network. The blockage event may be cleared due to a maintenance event 1110d being scheduled, where maintenance of the wastewater asset was performed.

In this example, jetting of the downstream pipe connected to example wastewater asset was performed at 19:00 on 11 Aug. 2021 after which the normalised wastewater measurements 1102 lowered somewhat but still remained above predicted maximum wastewater threshold 1108b for another continuous period of time for the required anomaly detection duration 1110e until the morning of 11 Aug. 2021 23:40, which was detected and alerted to the maintenance crew for resumption of jetting after 23:40 11 Aug. 2021, where a brick was removed from the sewer. The resumption of the normal wastewater flow is indicated in event 1110f in which the normalised wastewater measurements 1102 fell and remained inside the predicted minimum and maximum wastewater thresholds 1108a and 1108b. Although a follow-up site check as performed on 23:15 on 12 Aug. 2021 to check, where the wastewater level was determined to be lower than pre-blockage indicating the entire blockage had been removed and wastewater asset and pipes connected thereto had been restored to normal operation.

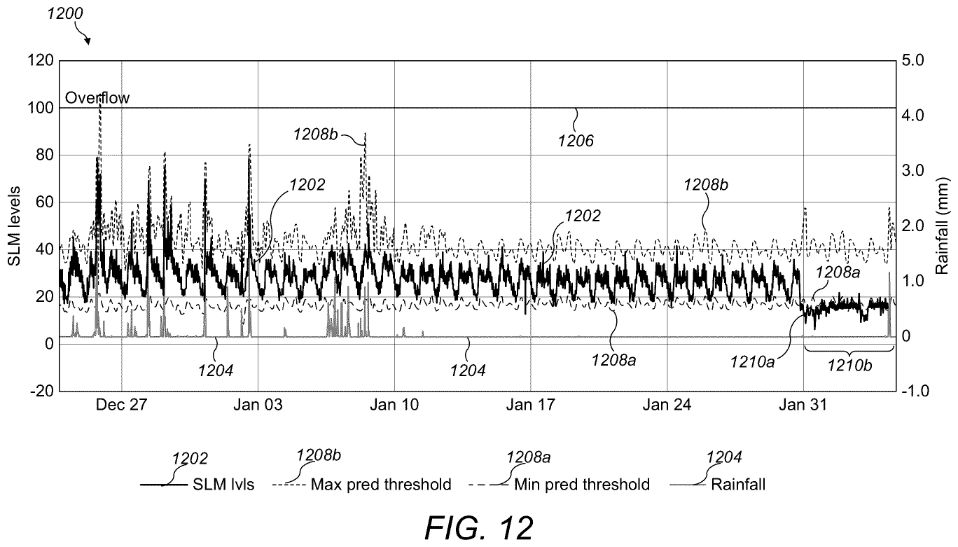

FIG. 12 illustrates an example plot 1200 of an upstream blockage anomaly event being detected for an example wastewater asset of a wastewater network according to some embodiments of the invention. On this plot 1200, the x-axis represents time duration over a time period of 1 month from 27 December to 31 January, and the left y-axis represents normalised wastewater level or flow measurements 1202 (e.g., Sewer Level Measurements (SLM)), normalised as a capacity percentage in relation to the capacity of the example wastewater asset to which the sensor is calibrated. On this plot 1200, rainfall measurement data 1204 in relation to the example wastewater asset is also plotted, where the right y-axis of plot 1200 represents rainfall in millimetres (mm). The normalised wastewater measurements 1202 may be normalised as described with reference to operation 202 of FIG. 2 and/or as described herein. The rainfall measurement data 1204 may comprise hyper-local rainfall data estimated from rainfall data periodically received from a weather service every M time units (e.g., every 15 minutes) for the example wastewater asset as described with reference to FIGS. 8a-8e and/or as herein described. The plot 1200 also illustrates that a capacity of 100% represents an overflow level 1206, whereby when the wastewater asset reaches 100% capacity wastewater may be redirected via an overflow mechanism or pipe away from the wastewater asset site to prevent flooding and the like.

The operation of the ML anomaly detection unit 110 of wastewater system 100 is similar to that as described with reference to FIGS. 1a to 11. The plot 1200 shows an example of the resulting predicted minimum and maximum wastewater thresholds 1208a and 1208b, respectively, represented as dashed lines dynamically changing over the 1-month time period as a function of the rainfall 1204 affecting the example wastewater asset. It is noted that the predicted minimum and maximum wastewater thresholds 1208a and 1208b represent a prediction of minimum and maximum wastewater thresholds 1208a and 1208b when wastewater asset operates under normal conditions. It can be seen that in normal conditions (e.g., a normal flow or level of wastewater flowing through the example wastewater asset), the predicted minimum and maximum wastewater thresholds 1208a and 1208b track based on rainfall 1204 the normalised wastewater measurements 1202. This is when the normalised wastewater measurements 1202 remain inside the predicted minimum and maximum wastewater thresholds 1208a and 1208b.

The example wastewater asset operates relatively normally until about 31 January in which an upstream blockage event 1210a started to occur in which the normalised wastewater measurements 1202 fell below the predicted minimum wastewater threshold 1208b for a continuous period of time for the required anomaly detection duration 1210b for the wastewater asset, after which an upstream blockage event is detected and alerted to the wastewater management system of the wastewater network. Maintenance may then be scheduled and performed upstream of the example wastewater asset. In this case, the blockage may be pinpointed by examining or determining whether a downstream blockage alert was received in relation to an upstream wastewater asset that is connected to the example wastewater asset. That is, the blockage may be pinpoint based on an upstream blockage being detected and alerted for a first wastewater asset and a downstream blockage being detected and alerted for a second wastewater asset directly upstream of the first wastewater asset.

The blockage may be pinpointed and removed for restoring normal operation of example wastewater asset and/or other wastewater assets in the wastewater network.

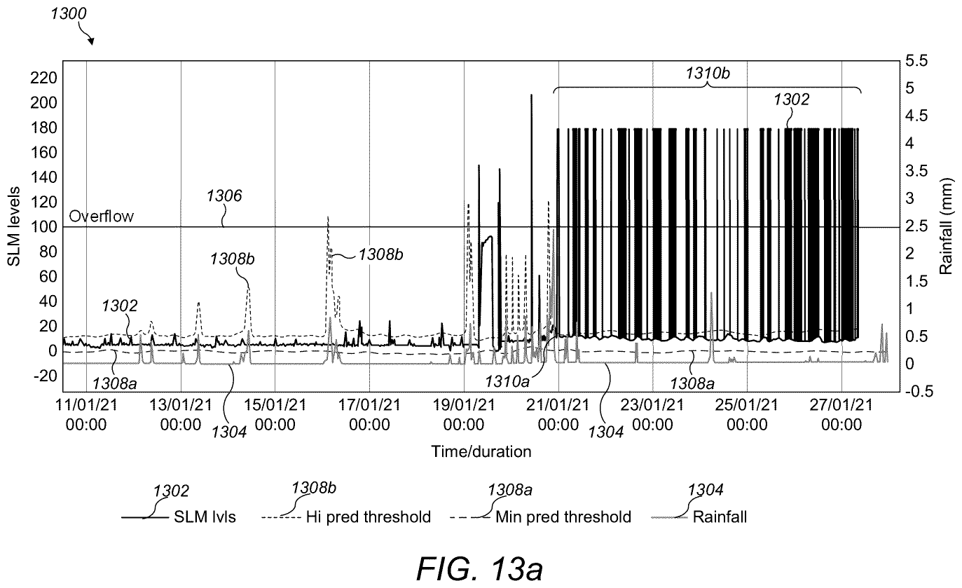

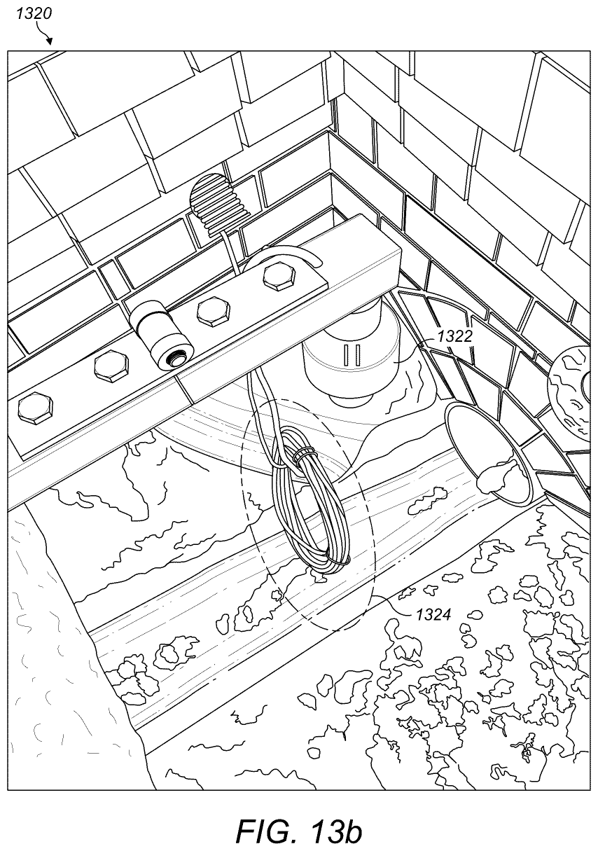

FIG. 13a illustrates an example plot 1300 of a sensor anomaly event being detected for a wastewater asset of a wastewater network according to some embodiments of the invention. On this plot 1300, the x-axis represents time duration over a time period of 9 days, and the left y-axis represents normalised wastewater level or flow measurements 1302 (e.g., Sewer Level Measurements (SLM)), normalised as a capacity percentage in relation to the capacity of the example wastewater asset to which the sensor is calibrated. On this plot 1300, rainfall measurement data 1304 in relation to the example wastewater asset is also plotted, where the right y-axis of plot 1300 represents rainfall in millimetres (mm). The normalised wastewater measurements 1302 may be normalised as described with reference to operation 202 of FIG. 2 and/or as described herein. The rainfall measurement data 1304 may comprise hyper-local rainfall data estimated from rainfall data periodically received from a weather service every M time units (e.g., every 15 minutes) for the example wastewater asset as described with reference to FIGS. 8a-8e and/or as herein described. The plot 1300 also illustrates that a capacity of 100% represents an overflow level 1306, whereby when the wastewater asset reaches 100% capacity wastewater may be redirected via an overflow mechanism or pipe away from the wastewater asset site to prevent flooding and the like.

The operation of the ML anomaly detection unit 110 of wastewater system 100 is similar to that as described with reference to FIGS. 1a to 12. The plot 1300 shows an example of the resulting predicted minimum and maximum wastewater thresholds 1308a and 1308b, respectively, represented as dashed lines dynamically changing over the 9-day time period as a function of the rainfall 1304 affecting the example wastewater asset. It is noted that the predicted minimum and maximum wastewater thresholds 1308a and 1308b represent a prediction of minimum and maximum wastewater thresholds 1308a and 1308b when wastewater asset operates under normal conditions. It can be seen that in normal conditions (e.g., a normal flow or level of wastewater flowing through the example wastewater asset), the predicted minimum and maximum wastewater thresholds 1308a and 1308b track based on rainfall 1304 the normalised wastewater measurements 1302. This is when the normalised wastewater measurements 1302 remain inside the predicted minimum and maximum wastewater thresholds 1308a and 1308b.

The example wastewater asset operates relatively normally until about day 6 in which a sensor anomaly event 1310a started to occur based on a sensor anomaly pattern in which the normalised wastewater measurements 1302 oscillated between inside the predicted minimum and minimum wastewater threshold 1308a and 1308b to outside the maximum wastewater threshold 1308b for a continuous period of time for the required anomaly detection duration 1310b for the wastewater asset, after which the sensor anomaly event is detected and alerted to the wastewater management system of the wastewater network. The sensor anomaly pattern and event that is detected represents a sensor misalignment or debris issue, where either the sensor beam is intermittently taking readings off obstacles or iron steps in the example wastewater asset or some debris caught in the wastewater asset may be interfering with the sensor reading. Maintenance may then be scheduled and performed to restore the sensor (e.g., realign, remove debris, repair the sensor etc., and/or replace the sensor). Once fixed, normal operation of the sensor of example wastewater asset may resume.

FIG. 13b illustrates the example wastewater asset 1320 of FIG. 13a in which the sensor 1322 of the example wastewater asset developed a fault and a sensor anomaly detection event occurred as illustrated in events 1310a-1310b of FIG. 13a. When maintenance crew was sent to repair the sensor 1322, they found the sensor cable 1324 had come loose and have been intermittently interfering with the sensor beam of sensor 1322 causing the intermittent spikes over the continuous time period of the anomaly duration 1310b indicated in FIG. 13a. The cable was retied to the sensor mount and normal operation of the sensor of example wastewater asset was able to resume.

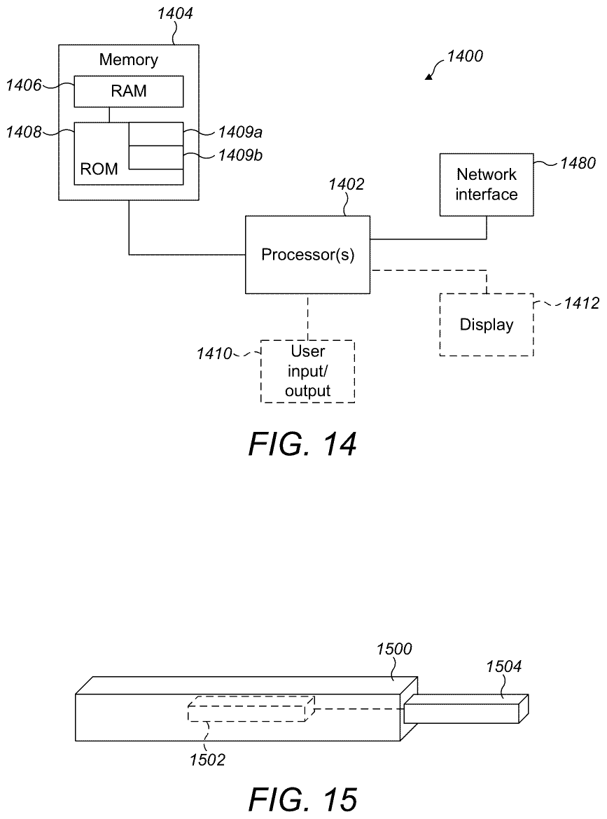

FIG. 14 illustrates a schematic example of a computing system/apparatus 1400 for performing any of the methods, operations or processes described herein and/or for implementing any of the systems, units and/or apparatus as described herein. The computing system/apparatus 1400 shown is an example of a computing device or platform. It will be appreciated by the skilled person that other types of computing devices/systems/platforms may alternatively be used to implement the methods described herein, such as a distributed computing system.

The apparatus (or system) 1400 comprises one or more processors 1402 (e.g., CPUs). The one or more processors 1402 control operation of other components of the system/apparatus 1400. The system/apparatus 1400 may be part of a computing device, computing system, distributed computing system, cloud computing platform and the like for implementing the functionality of the systems/apparatus and/or one or more methods/operations/processes as described herein. The one or more processors 1402 may, for example, comprise a general-purpose processor. The one or more processors 1402 may be a single core device or a multiple core device. The one or more processors 1402 may comprise a Central Processing Unit (CPU) or a graphical processing unit (GPU). Alternatively, the one or more processors 1402 may comprise specialized processing hardware, for instance a RISC processor or programmable hardware with embedded firmware. Multiple processors may be included. In some embodiments, the one or more processors 1402 may be part of a distributed computing system such as a cloud computing system and/or cloud computing platform.

The system/apparatus comprises memory system or memory 1404 including a working or volatile memory 1406. The one or more processors may access the volatile memory 1406 in order to process data and may control the storage of data 1407 in memory. The volatile memory 1406 may comprise RAM of any type, for example, Static RAM (SRAM), Dynamic RAM (DRAM), or it may comprise Flash memory, such as an SD-Card. In some embodiments, the memory 1404 and/or one or more volatile memories 1406 may comprise a multiple of a plurality of memory 1404 forming part of the distributed computing system such as the cloud computing system and/or cloud computing platform and the like.

The system/apparatus comprises a non-volatile memory 1408. The non-volatile memory 1408 may store a set of operation or operating system instructions 1409a for controlling the operation of the processors 1402 in the form of computer readable instructions and/or software instructions 1409b in the form of computer readable instructions, which when executed on the one or more processors 1402 cause the processors to implement the methods, processes, operations and/or functionality of the ML anomaly detection apparatus, ML models and/or anomaly detection as described herein. The non-volatile memory 1408 may be a memory of any kind such as a Read Only Memory (ROM), a Flash memory, SD drive, a magnetic drive memory or magnetic disc drive memory and the like as the application demands. In some embodiments, the non-volatile memory 1408 may comprise a multiple of a plurality of non-volatile memory 1408 forming part of the distributed computing system such as the cloud computing system and/or cloud computing platform and the like.

The one or more processors 1402 are configured to execute operating instructions 1409a and/or software instructions 1409b to cause the system/apparatus to perform any of the methods or processes described herein. The operating instructions 1409a may comprise code (i.e., drivers) relating to the hardware components of the system/apparatus 1400, as well as code relating to the basic operation of the system/apparatus 1400. Generally speaking, the one or more processors 1402 execute one or more instructions of the operating instructions 1409a and/or software instructions 1409b, which are stored permanently or semi-permanently in the non-volatile memory 1408, using the volatile memory 1406 to store temporarily data generated during execution of said operating instructions 1409a and/or software instructions 1409b.

The one or more processors 1402 may be connected to a network interface 1408 including a transmitter (TX) and a receiver (RX) for communicating over a network with other apparatus and systems such as wastewater assets, wastewater network, wastewater network management systems, environmental data measurement services and/or operators and/or any other apparatus, service, system and/or device as the application demands. The one or more processors 1402 may, optionally, be connected with a user interface (UI) 1410 for user or operator input for instructing or using the computing system and/or for outputting data therefrom. The one or more processors 1402 may, optionally, be connected with a display 1412 for displaying output to a user or operator. The at least one processor 1402, with the at least one memory 1404 and the computer program code 1409a, 1409b are arranged to cause the computing system 1400 to at least perform at least the operations, methods, and/or processes, for example as disclosed in relation to the schematic diagrams, flow diagrams or operations as described with any of FIGS. 1a to 13 and related features thereof.

FIG. 15 shows a non-transitory media 1500 according to some embodiments. The non-transitory media 1500 may include a computer readable storage medium 1502 and/or input/output mechanism 1504 for enabling a computing system 1400 to access said computer-readable medium 1502. Although in this example the non-transitory media is USB stick, this is by way of example only and the invention is not so limited, the skilled person would appreciate the non-transitory media 1500 may be any other type of computer readable media or medium such as, for example, a CD, a DVD, a USB stick, a blue ray disk, flash drive etc. and/or any other computer readable media as the application demands. The non-transitory media 1500 stores computer program code, causing an apparatus to perform one or more of the methods, operations, processors of any preceding process for example as disclosed in relation to the flow diagrams and schematic diagrams of FIGS. 1a to 14 and related features thereof.

Implementations of the methods or processes described herein may be realized as in digital electronic circuitry, integrated circuitry, specially designed ASICs (application specific integrated circuits), computer hardware, firmware, software, and/or combinations thereof. These may include computer program products (such as software stored on e.g., magnetic discs, optical disks, memory, Programmable Logic Devices) comprising computer readable instructions that, when executed by a computer, such as that described in relation to FIG. 14, cause the computer to perform one or more of the methods described herein.

Any system feature as described herein may also be provided as a method or process feature, and vice versa. As used herein, means plus function features may be expressed alternatively in terms of their corresponding structure. In particular, method aspects may be applied to system aspects, and vice versa.

Furthermore, any, some and/or all features in one aspect can be applied to any, some and/or all features in any other aspect, in any appropriate combination. It should also be appreciated that particular combinations of the various features described and defined in any aspects of the invention can be implemented and/or supplied and/or used independently.

Although several embodiments have been shown and described, it would be appreciated by those skilled in the art that changes may be made in these embodiments without departing from the principles of this disclosure, the scope of which is defined in the claims and their equivalents.

1. A computer-implemented method for detecting anomalies at a wastewater asset of a wastewater network, the wastewater asset comprising a sensor configured for performing measurements associated with wastewater flow through the wastewater asset, the method comprising:
receiving current environmental data comprising rainfall data associated with the wastewater asset, the current environmental data affecting the flow of wastewater through the wastewater asset;
receiving, from the sensor of the wastewater asset, real-time wastewater measurements associated with the wastewater flow at the wastewater asset;
applying the received current environmental data to a trained machine learning, ML, model configured for predicting, in real-time, minimum and maximum thresholds associated with wastewater flow through the wastewater asset;
detecting an anomaly at the wastewater asset when one or more of multiple real-time wastewater measurements at the wastewater asset at least exceeds the a corresponding predicted maximum wastewater threshold and/or reaches below the a corresponding predicted minimum wastewater threshold over an anomaly duration associated with the anomaly; and
sending an indication of the detected anomaly at the wastewater asset to an operator monitoring the wastewater network.

2. The computer-implemented method of claim 1, wherein the sensor comprising at least one sensor from the group of:
water level sensor;
water flow sensor;
water pressure sensor;
current pumping sensor;
any other sensor configured for performing measurements associated with the wastewater flow through the wastewater asset.

3. The computer-implemented method of claim 1, wherein detecting the anomaly further comprises comparing a pattern created by the one or more multiple real-time wastewater measurements in relation to the predicted maximum and/or minimum thresholds over the time interval against a set of anomaly patterns, each anomaly pattern defining a specific type of anomaly.

4. The computer-implemented method of claim 3, wherein detecting the anomaly further comprises identifying an anomaly based on a similar or matching anomaly pattern, and determining the identified anomaly has been detected when the pattern created by the real-time wastewater measurements meets an anomaly duration associated with the anomaly pattern.

5. The computer-implemented method of claim 1, wherein the anomaly may be based on one or more from the group of:
an upstream blockage;
a downstream blockage;
a measurement sensor fault or error; and
any other type of anomaly detectable via wastewater flowing through said wastewater asset.

6. The computer-implemented method of claim 4, wherein the measurement sensor fault or error comprises at least one from the group of:
sensor misalignment issue;
sensor calibration issue;
sensor communications issue;
sensor obstacle issue; and
any other sensor fault, error or issue causing incorrect wastewater measurements being performed at the wastewater asset.

7. The computer-implemented method of claim 1, wherein detecting the anomaly further comprising:
detecting a downstream blockage of the wastewater network downstream of the wastewater asset when the wastewater measurements exceeds the predicted maximum wastewater threshold for multiple contiguous time instances over an anomaly duration associated with downstream blockage;
detecting a upstream blockage of the wastewater network that is upstream of the wastewater asset when the wastewater measurements are less than the predicted minimum wastewater threshold for multiple contiguous time instances over an anomaly duration associated with upstream blockage; and
detecting a measurement sensor anomaly when the wastewater measurements oscillates between inside and outside the limits set by the predicted maximum wastewater threshold and/or the predicted minimum wastewater threshold over multiple contiguous time instances over an anomaly duration associated with a sensor anomaly.

8. The computer-implemented method as claimed in claim 1, further comprising normalising the received wastewater measurements based on a maximum and minimum capacity of the wastewater asset, and using the normalised wastewater measurements for detecting the anomaly, wherein detecting the anomaly further comprising detecting the anomaly at the wastewater asset when one or more of multiple real-time normalised wastewater measurements at the wastewater asset at least exceeds the corresponding predicted maximum wastewater threshold and/or reaches below the corresponding predicted minimum wastewater threshold over an anomaly duration associated with the anomaly.

9. The computer-implemented method of claim 1, wherein environmental data associated with the wastewater asset comprises one or more types of environmental data from the group of:
rainfall data;
river level data;
tidal data;
flood water level data;
ground water level data;
any other type of environmental data affecting the wastewater flow through the wastewater asset.

10. The computer-implemented method of claim 1, wherein applying the received current environmental data to the trained ML model further comprising:
synchronising a time series received current environmental data with a common time interval M between datapoints, the common time interval M used by a training dataset for training said trained ML model;
depending on the type of environmental data, estimating hyper-local environmental data based on processing one or more types of the synchronised received current environmental data; and
inputting the processed synchronised current environmental data to the trained ML model configured for outputting a prediction of the minimum and maximum wastewater thresholds associated with wastewater flow through the wastewater asset.

11. The computer-implemented method of claim 1, wherein the received current environmental data comprises rainfall data associated with the wastewater asset, the rainfall data including first rainfall data corresponding to a first rainfall area the wastewater asset is located within, and a plurality of other rainfall data corresponding to rainfall areas adjacent to the first rainfall area, wherein applying the received current environmental data to the trained ML model further comprising:
calculating a hyper-local rainfall estimate at the location of the wastewater asset based a weighted combination of the first rainfall estimate and the plurality of other rainfall data in relation to the location of the wastewater asset within the first rainfall area and the relative location of the wastewater asset to each of the plurality of other rainfall areas; and
inputting the current hyper-local rainfall estimate to the trained ML model configured for outputting a prediction of the minimum and maximum wastewater thresholds associated with wastewater flow through the wastewater asset.

12. The computer-implemented method of claim 11, wherein calculating the hyper-local rainfall estimate associated with the wastewater asset further comprising:
dividing a rainfall grid area in which the wastewater asset is located within into quadrants;
identifying a grid area quadrant of the rainfall grid area that the wastewater asset is located within;
selecting at least three rainfall grid areas adjacent to the identified grid area quadrant the wastewater asset is located within;
calculating a rectangle formed from the centers of the at least three rainfall grid areas and the rainfall grid area the wastewater asset is located within, wherein the wastewater asset is located within said rectangle;
projecting the location of the wastewater asset onto each of the line segments or edges of the rectangle based on orthogonally projecting lines from the wastewater asset to each line segment or edge to form intersection locations on each line segment or edge for estimating intersection rainfall dataset estimates for said line segments or edges;
calculating, for each line segment or edge of the rectangle, an intersection rainfall estimate dataset based a linear interpolation using distances between each center of the grid areas corresponding to said each line segment or edge and the intersection location for said each line segment and the corresponding rainfall datasets associated with said centers the grid areas;
calculating, for each projection line, an intermediate rainfall estimate dataset based a linear interpolation using distances between each pair of intersection locations on said each projection line and said wastewater asset and the corresponding intersection estimate rainfall datasets associated with said intersection locations on said each projection line; and
calculating a hyperlocal rainfall dataset for said wastewater asset based on averaging the intermediate rainfall estimate datasets.

13. The computer-implemented method of claim 1, further comprising performing training of the ML model based on using an ML algorithm to train model parameters defining the ML model for predicting minimum and maximum thresholds associated with wastewater flow through the wastewater asset for use in anomaly detection based on a training dataset comprising data representative of historical wastewater measurement data for the wastewater asset and historical environmental data comprising historical rainfall data associated with the wastewater asset.

14. The computer-implemented method of claim 13, wherein a historical wastewater measurement data and historical environmental data are timeseries data, the method further comprising:
normalising the timeseries historical wastewater measurement data based on the maximum and minimum capacity of the wastewater asset; and
processing a timeseries normalised historical wastewater measurement data for the wastewater asset to be synchronised with at least the timeseries rainfall data of the historical environmental data associated with the wastewater asset.

15. The computer-implemented method of claim 13, wherein training further comprising:
performing hyperparameter tuning using the ML algorithm based on training a plurality of sets of ML models using different combinations of hyperparameters, each set of ML models comprising a mean ML model, a minimum ML model and a maximum ML model, wherein:
the mean ML model is trained and configured for predicting a time series mean values in the normalised historical wastewater measurement data based on at least rainfall data as input;
the minimum ML model is trained and configured for predicting the time series minimum values in the normalised historical wastewater measurement data based on at least rainfall data as input; and
the maximum ML model is trained and configured for predicting the time series maximum values in the normalised historical wastewater measurement data based on at least rainfall data as input;
scoring and ranking each of the trained ML models of the plurality of sets of ML models based on root mean squared error and mean squared error;
selecting the best ranked trained ML model;
selecting corresponding minimum and maximum trained ML models from the set of ML models that the selected best ranked trained ML model belongs; and
generating final trained ML model for predicting minimum and maximum wastewater thresholds based on using the selected minimum and maximum trained ML models.

16. The computer-implemented method of claim 13, wherein training further comprising:
performing hyperparameter tuning of the ML algorithm based on training a plurality of ML models using different combinations of hyperparameters associated with the ML algorithm and training dataset, wherein each comprises a mean ML model trained and configured for predicting the time series mean values in the normalised historical wastewater measurement data based on at least rainfall data as input;
scoring and ranking each of the trained mean ML models of the plurality of ML models based on root mean squared error and mean squared error model performance metrics;
selecting the best ranked trained mean ML model;
using hyperparameters of the selected best ranked trained mean ML model to generate a corresponding minimum and maximum trained ML models, wherein:
a minimum ML model is trained and configured for predicting the time series minimum values in the normalised historical wastewater measurement data based on at least rainfall data as input; and
the maximum ML model is trained and configured for predicting the time series maximum values in the normalised historical wastewater measurement data based on at least rainfall data as input; and
generating final trained ML model for predicting minimum and maximum wastewater thresholds based on using the corresponding minimum and maximum trained ML models.

17. The computer-implemented method of claim 14, wherein the historical rainfall data is a timeseries dataset with a time interval M between datapoints, and the historical wastewater measurement data is a timeseries dataset with a time interval N between datapoints, where M>=N, further comprising generating a synchronised historical wastewater measurement dataset that forms a timeseries dataset with a time interval M between datapoints based on calculating the mean, minimum and maximum for each i-th datapoint from those datapoints of the historical wastewater measurement data falling between the (i-1)-th datapoint and the i-th datapoint within said each time interval M, wherein the training dataset comprises the mean, minimum and maximum values of the synchronised historical wastewater measurement dataset.

18. The computer-implemented method of claim 17, further comprising:
performing a first data clean-up of the normalised synchronised historical wastewater measurement dataset based on:
performing statistical analysis of the normalised synchronised historical wastewater measurement dataset for identifying blocks of outlier datapoints;
generating a first clean wastewater measurement dataset based on removing the identified outlier datapoints from the normalised synchronised historical wastewater measurement dataset; and
generating a first rainfall dataset based on removing the corresponding rainfall datapoints associated with the identified outlier datapoints from the historical rainfall data;
performing second data clean-up of the first clean wastewater measurement dataset based on:
performing further statistical analysis to analyse long and short-term average behaviour of the first clean wastewater measurement dataset for identifying, based on a ruleset, inaccurate of discontinuous measurement data for interpolation or removal;
generating a second clean wastewater measurement dataset based on filtering a identified measurement data using interpolation or removal; and
generating a second rainfall dataset based on removing the corresponding rainfall datapoints associated with the removed datapoints from the first clean wastewater measurement dataset from the historical rainfall dataset;
performing a third data clean-up of the second clean wastewater measurement dataset based on:
identifying from the second clean wastewater measurement dataset exclusion events comprising one or more of: a) blockage and sensor fault events; b) rainfall events; c) dry weather events; and/or d) other feature events causing noisy or spurious data;
generating a clean wastewater measurement dataset based on removing the blockage and sensor fault events and other feature events causing noise or spurious data from the second clean wastewater measurement dataset; and
generating a clean rainfall dataset based on removing the corresponding rainfall datapoints associated with the removed identified outlier datapoints from the historical rainfall data; and
generating the training dataset based on the clean wastewater measurement dataset and the clean third rainfall dataset.

19. The computer-implemented method of claim 18, further comprising:
generating a dry weather dataset for the wastewater asset based on removing identified rainfall events from the clean wastewater measurement dataset;
training a dry weather ML model based on using an ML algorithm to train model parameters defining the dry weather ML model for predicting minimum and maximum dry weather thresholds associated with wastewater flow through the wastewater asset for use in anomaly detection based on a training dry weather dataset comprising data representative of the generated dry weather dataset;
training a wet weather ML model based on using the ML algorithm to train model parameters defining the wet weather ML model for predicting minimum and maximum wet weather thresholds associated with wastewater flow through the wastewater asset for use in anomaly detection based on a training dataset comprising data representative of the clean wastewater measurement dataset and the clean third rainfall dataset associated with the wastewater asset; and
forming a trained ML model based on the trained dry weather ML model and trained wet weather ML model, wherein the trained ML model is configured to predict minimum and maximum wastewater thresholds, where the predicted minimum wastewater threshold comprises a combination of the predicted minimum dry weather threshold and the predicted minimum wet weather threshold, and the predicted maximum wastewater threshold comprises a combination of the predicted maximum dry weather threshold and the predicted maximum wet weather threshold.

20. The computer-implemented method of claim 18, performing statistical analysis of the normalised synchronised historical wastewater measurement dataset for identifying blocks of outlier datapoints further comprising:
generating a histogram dispersion graph for the normalised synchronised historical wastewater measurement dataset;
identifying the outlier blocks, if any, in the histogram dispersion graph based on comparing the histogram dispersion graph with an ideal histogram data pattern associated with the wastewater asset; and
generating first clean wastewater dataset based on removing any identified outlier blocks from the normalised synchronised historical wastewater measurement dataset.

21. The computer-implemented method of claim 18, wherein the normalised synchronised historical wastewater measurement dataset includes a plurality of current normalised synchronised wastewater measurements, the method further comprising:
generating a histogram dispersion graph for the normalised synchronised historical wastewater measurement dataset;
identifying the outlier blocks, if any, in the histogram dispersion graph based on comparing the histogram dispersion graph with an ideal histogram data pattern associated with the wastewater asset;
determining whether any of the identified outlier blocks include one or more of the plurality of current normalised synchronised wastewater measurements for an anomaly duration period or time window up to a current time instance; and
detecting an anomaly based on the determination, and, as an option, further comprising identifying the detected anomaly based on:
identifying a type of sensor anomaly based on matching or comparing the identified outlier blocks with one or more anomaly statistical patterns, the anomaly statistical patterns including at least one of an iron step pattern, sensor misalignment pattern and a sensor calibration pattern; or
identifying any other type of anomaly based on matching or comparing the identified outlier blocks with one or more corresponding anomaly statistical patterns associated thereto.

22. The computer-implemented method of claim 13, wherein the ML algorithm comprising at least one from the group of:
regression learning algorithm;
neural network;
extreme gradient boost regressor algorithm;
Adaptive Boosting algorithm;
Gradient boosting algorithm; and
any other statistical classification meta-algorithm;
any other ML algorithm suitable for training model parameters of an ML model for tracking a behaviour of wastewater flow through a wastewater asset and for predicting data representative of a minimum wastewater threshold and maximum wastewater threshold for said wastewater asset; and
any other statistical classification meta-algorithm, boosting algorithm or regression algorithm suitable for training model parameters of an ML model for tracking the behaviour of wastewater flow through a wastewater asset and for predicting data representative of a minimum wastewater threshold and maximum wastewater threshold for said wastewater asset.

23. The computer-implemented method of claim 1, wherein the computer-implemented method is a method of operating an anomaly detection apparatus for detecting anomalies at one or more wastewater assets of the wastewater network, the wastewater network further comprising a plurality of wastewater assets, each wastewater asset connected to another wastewater asset of the plurality of wastewater assets by a corresponding wastewater pipe to form the wastewater network, each wastewater asset comprising a sensor configured for performing measurements associated with wastewater flow through the wastewater asset, the method further comprising:
performing anomaly detection for each of the wastewater assets of the plurality of wastewater assets based on:
receiving, from one or more weather measurement services, current environmental data comprising rainfall data associated with said each wastewater asset, the current environmental data affecting the flow of wastewater through said each wastewater asset;
receiving, from the sensor of said each wastewater asset, real-time wastewater measurements associated with the wastewater flow at said each wastewater asset;
applying the received current environmental data to a trained ML model configured for predicting, in real-time, minimum and maximum wastewater thresholds associated with wastewater flow through said each wastewater asset, wherein the ML model is trained to predict the minimum wastewater threshold using training data comprising time series minimum values of historical wastewater measurement data of said each wastewater asset given corresponding rainfall data as input, and the ML model is trained to predict the maximum wastewater threshold using training data comprising time series maximum values of historical wastewater measurement data of said each wastewater asset given corresponding rainfall data as input;
detecting a downstream blockage anomaly at said each wastewater asset when one or more of multiple real-time wastewater measurements at said each wastewater asset at least exceeds the corresponding predicted maximum wastewater threshold for multiple contiguous time instances over an anomaly duration associated with downstream blockage; and
detecting an upstream blockage anomaly at said each wastewater asset when one or more of multiple real-time wastewater measurements reaches below the corresponding predicted minimum wastewater threshold for multiple contiguous time instances over an anomaly duration associated with upstream blockage; and
sending the indication of any detected blockages at each wastewater asset to the operator monitoring the wastewater network.

24. An apparatus comprising a processor and a computer readable memory connected together, the memory comprising non-transient computer instructions stored thereon which, when executed on the processor, causes the processor to perform the computer-implemented steps of:
receiving current environmental data comprising rainfall data associated with the wastewater asset, the current environmental data affecting the flow of wastewater through the wastewater asset;
receiving, from the sensor of the wastewater asset, real-time wastewater measurements associated with the wastewater flow at the wastewater asset;
applying the received current environmental data to a trained machine learning, ML, model configured for predicting, in real-time, minimum and maximum thresholds associated with wastewater flow through the wastewater asset;
detecting an anomaly at the wastewater asset when one or more of multiple real-time wastewater measurements at the wastewater asset at least exceeds a corresponding predicted maximum wastewater threshold and/or reaches below a corresponding predicted minimum wastewater threshold over an anomaly duration associated with the anomaly; and
sending an indication of the detected anomaly at the wastewater asset to an operator monitoring the wastewater network.

25. A wastewater management system comprising:
a wastewater network comprising a plurality of wastewater assets, wherein each wastewater asset comprises a sensor for measuring data representative of wastewater passing through said each wastewater asset;
an anomaly detection apparatus comprising a processor and a computer readable memory connected together, the memory comprising non-transient computer instructions stored thereon which, when executed on the processor, causes the processor to perform the computer-implemented steps of:
receiving current environmental data comprising rainfall data associated with the wastewater asset, the current environmental data affecting the flow of wastewater through the wastewater asset;
receiving, from the sensor of the wastewater asset, real-time wastewater measurements associated with the wastewater flow at the wastewater asset:
applying the received current environmental data to a trained machine learning, ML, model configured for predicting, in real-time, minimum and maximum thresholds associated with wastewater flow through the wastewater asset;
detecting an anomaly at the wastewater asset when one or more of multiple real-time wastewater measurements at the wastewater asset at least exceeds a corresponding predicted maximum wastewater threshold and/or reaches below a corresponding predicted minimum wastewater threshold over an anomaly duration associated with the anomaly; and
sending an indication of the detected anomaly at the wastewater asset to an operator monitoring the wastewater network;
wherein:
the anomaly detection apparatus receives wastewater measurements from each of the sensors over a communication network; and
the anomaly detection apparatus is configured for receiving over the communication network environmental data associated with each of the wastewater assets of the wastewater network.

26. (canceled)
